(19) United States
(12) Patent Application Publication
(10) Pub. No.: US 2026/0342710 A1
(43) Pub. Date: Oct. 29, 2026

(54) CONTROL COMMUNICATION SYSTEM

(71) Applicant: HITACHI HIGH-TECH CORPORATION, Minato-ku, Tokyo (JP)

(72) Inventors: Tatsuya MARUYAMA, Tokyo (JP); Junichi KITAMURA, Tokyo (JP); Koichi YAMAMOTO, Tokyo (JP); Yuji SUGAYA, Tokyo (JP)

(21) Appl. No.: 19/109,350

(22) PCT Filed: Dec. 19, 2023
(86) PCT No.: PCT/JP2023/045492

§ 371 Date: Mar. 6, 2025

(51) Int. Cl. H04L 45/121; H04L 1/18; H04L 67/12

(52) U.S. Cl. CPC H04L 45/121; H04L 1/18; H04L 67/12

(57) ABSTRACT

A control communication system including a control communication device including a communication unit that transmits a packet including control data, and a plurality of devices that are communicatively connected to a communication port formed in the communication unit and operate according to the received packet. The packet includes a packet data area in which the control data is selected and arranged, and is transmitted from the communication unit to the device connected to the communication unit. The control communication device generates the control data based on communication control information related to transmission and reception of the control data, stores a correspondence relationship between the device and the control data, and changes the communication control information related to the device based on the correspondence relationship when a state of the device is changed.

### TECHNICAL FIELD

The present invention relates to a control communication system, and more particularly to a technique for setting control communication performed in a control communication system.

### BACKGROUND ART

A control system supporting social infrastructure includes, for example, a sensor, a controller, and an actuator. In such a control system, a state of a physical object is acquired by the sensor and input to the controller, a control command value for the controller to instruct the actuator is calculated, and the actuator works on the physical object based on the command value. The control system executes, for example, desired control by cyclically repeating such a series of processing.

Examples of such a control system include factory automation (FA) in factories, process automation (PA) in chemical plants, a semiconductor manufacturing device, and a semiconductor inspection device. Further examples include a medical device, a distributed control system, a power system control system, a power generation plant, a water and sewage treatment system, and a steel control system.

In this way, PTL 1 discloses a communication control device that reconstructs a frame according to a communication state of a network including a plurality of nodes. Specifically, when a production device (a component mounting machine 1) suspends the production (mounting processing) and reconstructs the frame during execution of maintenance, the communication control device sets the entire data field as a target field, and reallocates the target field for each of the plurality of nodes, thereby reconstructing the frame by changing a ratio of each data section.

### CITATION LIST

### Patent Literature

PTL 1: WO2018/105047

### SUMMARY OF INVENTION

### Technical Problem

For example, in a large-scale control system or a complicated control system, a plurality of sensors, controllers, and actuators are connected via a network. In such a network, a technique of a control network is developed in order to satisfy a time constraint (for example, a worst delay), cost, reliability, and a requirement specific to an application field, which are requirements of a control system. In particular, driven by an increase in a scale and an increase in a level of a control system, or by recent progress of Industrial IoT, a control network constituting a control system is required to speed up communication, shorten a control communication period, increase a communication capacity, and the like.

By using a method corresponding to such a need, an increased communication capacity is achieved by introducing Ethernet (registered trademark) into the control network. In addition, after an operation of the control system, a change in a system configuration may be required in order to meet a changing requirement for the control system or to continuously improve performance of the control system. This change can be either adding a new communication control device or reducing the number of communication control devices improving the performance of a single communication control device, which can lead to a reduction in operational costs.

Cases when a change in a system configuration is required include, but are not limited to such cases, cases in which some or all of communication control devices need to be temporarily stopped when performing maintenance on the control system, or cases in which a maintenance communication control device needs to be added to the control system. According to the control system, even when some of the communication control devices are stopped, the other communication control devices need to continue communication.

Based on such a background, a technique corresponding to both improvement in communication performance and a change in a system configuration is required. However, there is a problem in achieving both improvement in the communication performance and adapting to the change in the system configuration. For example, in order to accommodate the change in the system configuration, normally, each communication control device is identified, and a unit of communication is for each communication control device. However, in such a communication method, communication data is required as many as the number of the communication control devices, and the communication performance decreases due to an increase in a communication delay and a decrease in communication bandwidth use efficiency due to overhead attached to the communication data.

For example, in an Ethernet frame, communication of a header, a frame check sequence (FCS), and an inter frame gap (IFG) is required in addition to the communication data for an application. These are overhead in the sense that they are necessary for communication but do not contain valid data for the application.

The invention aims mainly to solve the above problems.

The above and other objects and novel features of the invention will become apparent from the description of this specification and the accompanying drawings.

### Solution to Problem

In order to solve the above problems, the invention includes a control communication device including a communication unit that transmits a packet including control data, and a plurality of devices that are communicatively connected to a communication port formed in the communication unit and operate according to the received packet. The packet includes a packet data area in which the control data is selected and arranged, and is transmitted from the communication unit to the device connected to the communication unit. The control communication device generates the control data based on communication control information related to transmission and reception of the control data, stores a correspondence relationship between the device and the control data, and changes the communication control information related to the device based on the correspondence relationship when a state of the device is changed.

### Advantageous Effects of Invention

According to the invention, it is possible to provide a control system with excellent system adaptability, which is capable of changing a system configuration in response to a request for the control system while improving communication performance.

### BRIEF DESCRIPTION OF DRAWINGS

FIG. 1 is a schematic diagram showing a configuration example of a control communication system according to a first embodiment.

FIG. 2 is a block diagram showing a hardware structure example of a control device shown in FIG. 1.

FIG. 3 is a functional block diagram showing a functional configuration example of the control device shown in FIG. 1.

FIG. 4 is a diagram showing a configuration example of an EtherCAT frame transmitted on a control network shown in FIG. 1.

FIG. 5 is a block diagram showing a hardware structure example of a control target device shown in FIG. 1.

FIG. 6 is a block diagram showing a functional configuration example of a control target device communication control IC shown in FIG. 5.

FIG. 7 is a block diagram showing a functional configuration example of a control system configuration device shown in FIG. 1.

FIG. 8 is a flowchart showing an example of an operation step of each functional unit included in the control system configuration device shown in FIG. 7.

FIG. 9A is a diagram showing a specific example of the operation step shown in FIG. 8.

FIG. 9B is a diagram showing a specific example of the operation step shown in FIG. 8.

FIG. 9C is a diagram showing a specific example of the operation step shown in FIG. 8.

FIG. 9D is a diagram showing a specific example of the operation step shown in FIG. 8.

FIG. 10 is a flowchart showing an example of an execution step of transmission processing in the control device shown in FIG. 3.

FIG. 11 is a flowchart showing an example of an execution step of reception processing in the control device shown in FIG. 3.

FIG. 12 is a flowchart showing an example of abnormality determination processing performed by an abnormality determination unit in FIG. 3 and an execution step of abnormality corresponding processing performed by a retransmission unit.

FIG. 13 is a flowchart showing an example of an execution step when a system configuration is changed by a control target device selection unit, a datagram generation information change unit, and a control system configuration information storage unit in FIG. 3.

FIG. 14A is a diagram showing a specific example of the execution step shown in FIG. 13.

FIG. 14B is a diagram showing the specific example of the execution step shown in FIG. 13.

FIG. 14C is a diagram showing the specific example of the execution step shown in FIG. 13.

FIG. 14D is a diagram showing the specific example of the execution step shown in FIG. 13.

FIG. 15 is a block diagram showing a hardware structure example of a control device in FIG. 1 in a control communication system according to a second embodiment.

FIG. 16 is a functional block diagram showing a functional configuration example of the control device shown in FIG. 15.

FIG. 17 is a flowchart showing an example of abnormality determination processing performed by an abnormality determination unit shown in FIG. 16 and an execution step of abnormality corresponding processing performed by a retransmission unit and a redundant path control unit.

FIG. 18A is a schematic diagram showing an example of a communication method using a redundant path in the control communication system according to the second embodiment.

FIG. 18B is a schematic diagram showing an example of the communication method using the redundant path in the control communication system according to the second embodiment.

FIG. 19A is a schematic diagram showing an example of another communication method using the redundant path in the control communication system according to the second embodiment.

FIG. 19B is a schematic diagram showing an example of another communication method using the redundant path in the control communication system according to the second embodiment.

FIG. 20 is a diagram showing an example of a communication path when path abnormalities or failures in a control target device occur at a plurality of locations in a replication method shown in FIG. 18.

FIG. 21 is a diagram showing an example of the communication path when the path abnormalities or failures in the control target device occur at the plurality of locations in the forwarding method shown in FIG. 19.

FIG. 22A is a diagram showing an example of the communication path when an abnormality occurs in the communication path adjacent to the control device in the replication method shown in FIG. 18.

FIG. 22B is a diagram showing an example of the communication path when an abnormality occurs in the communication path adjacent to the control device in the forwarding method shown in FIG. 19.

FIG. 23 is a schematic diagram showing an operation example when the same logical address is assigned to and read from a plurality of control target devices after applying cable redundancy as a premise of a control communication system according to a third embodiment.

FIG. 24A is a schematic diagram showing an example of a method corresponding to a change in a system configuration using a mechanism of the logical address shown in FIG. 23.

FIG. 24B is a schematic diagram showing an example of a method corresponding to the change in the system configuration using the mechanism of the logical address shown in FIG. 23.

FIG. 24C is a schematic diagram showing an example of a method corresponding to the change in the system configuration using the mechanism of the logical address shown in FIG. 23.

FIG. 25A is a diagram showing a specific example in which FIG. 14B is changed.

FIG. 25B is a diagram showing a specific example in which FIG. 14C is changed.

FIG. 25C is a diagram showing a specific example in which FIG. 14D is changed.

### DESCRIPTION OF EMBODIMENTS

Hereinafter, embodiments of the invention will be described in detail with reference to the drawings. In all drawings for describing the embodiments, the same members are denoted by the same reference numerals in principle, and repeated description thereof will be omitted. When there are a plurality of components having the same or similar functions, the description may be made by assigning different subscripts to the same reference sign. For example, one component may be denoted by “1”, and a plurality of components may be distinguished by “1a”, “1b”, or the like. When it is not necessary to distinguish the plurality of components, the description may be made by omitting the subscripts.

### First Embodiment

### System Example

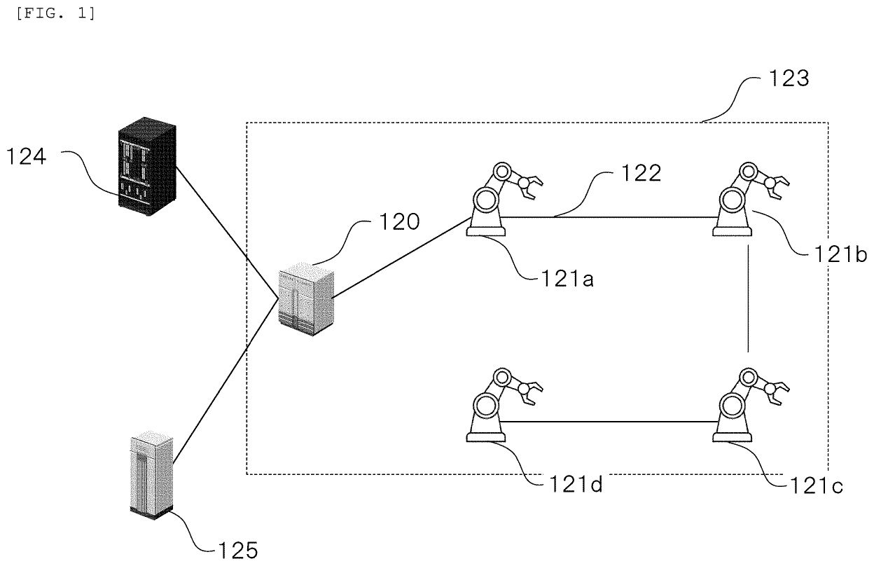

FIG. 1 is a schematic diagram showing a configuration example of a control communication system according to a first embodiment. The control communication system shown in FIG. 1 includes a control system 123, a control system configuration device 124, and a control system management device 125. The control system 123 includes a control device 120, in other words, a control communication device, a control target device 121, and a control network 122. Examples of the control system 123 include control systems of DCS or the like for a semiconductor manufacturing device, a semiconductor inspection device, a medical device such as a clinical testing device, factory automation (FA), and process automation (PA).

Further, examples of the control system 123 include a remote control system via a wireless network, a monitoring control and protection control system in the power field, a control system in an industrial device, an in-vehicle system, a construction machine or a railway vehicle, a railway ground signal system, and a control system in an aircraft. Alternatively, the control system 123 may be a component of the device. For example, the control system 123 may be a component of a chamber of an etching device or a sputtering device which is a semiconductor manufacturing device, a manufacturing line of an FA system, a device constituting a DCS, an in-vehicle system, and an aircraft control system.

The control device 120 communicates with and controls the control target devices 121 via the control network 122. The control device 120 transmits and receives communication packets to and from the control target device 121 called a sensor or an actuator. Accordingly, the control device 120 transmits control command values for controlling the control target device 121, acquires measurement values and sensor information of the control target device 121, and performs various settings for the control target device 121.

The control device 120 is a device that exchanges sampling data, a control command, and a state signal in a control system such as a controller in a semiconductor manufacturing device or a semiconductor inspection device, a central control device of a distributed control system (DCS), and a protection controllers of a power system. At this time, the control device 120 may store a plurality of pieces of data in the same control system in a packet. The control device 120 may support a software virtualization technology or a software container technology, and may be implemented to manage an application or an operating system (OS) as a container by virtualization.

Examples of the control device 120 include a dedicated controller, an industrial personal computer, a control computer, a DCS controller, a multi-access edge computing (MEC) device, a computer cloud, a server, and a supervisory control and data acquisition (SCADA) server. Further examples of the control device 120 include a programmable logic controller (PLC), an intelligent electronic device (IED), protection controllers, and a cloud server.

The control target device 121 is a device such as a sensor and an actuator, and executes control and various settings according to a control command received from the control device 120 via the control network 122. The control target device 121 acquires a state and information of a device and transmits the state and the information to the control device 120 via the control network 122. The control target device 121 may only have a function of inputting information such as a sensor, may only have a function of outputting information such as an actuator, or may have both functions of inputting and outputting.

Examples of the control target device 121 include industrial robots such as a mobile robot, a humanoid robot, and a robot arm. Examples of the control target device 121 include an automated guided vehicle (AGV), an autonomous mobile robot (AMR), and an autonomous mobile object or a remote-controlled mobile object. Examples of the control target device 121 include medical devices such as a chip mounter, a machine tool table, a processing device, a machine tool, a semiconductor manufacturing device, a semiconductor inspection device, and a clinical test device, and motors, inverters, servo amplifiers, and servo motors in the manufacturing device.

Alternatively, examples of the control target device 121 include a power device such as a circuit breaker or a disconnector, and various sensors (an encoder, a temperature sensor, a pressure sensor, and the like). Further examples of the control target device 121 include a dedicated controller, an industrial personal computer, a control computer, a DCS controller, a SCADA device, a PLC, a smartphone or a communication device including a wireless communication interface, an intelligent electronic device (IED), a merging unit (MU), and protection controllers.

The control network 122 is a network that connects the control device 120 and one or more control target device 121. Examples of the control network 122 include a network based on IEEE 802.3 (Ethernet (registered trademark) ) including an EtherCAT (registered trademark), IEC61784, and time sensitive networking (TSN). Regarding the IEEE 802.3, examples include standards that support communication speeds such as 100 Mbps, 1 Gbps, multi-gigabit Ethernet, and 10 Gbps, and the use of jumbo frames.

Examples of the control network 122 further include a core network in a wireless network such as 5G, 6G, and 4G, various wired network such as a controller area network (CAN, registered trademark), RS-232C, and a universal serial bus (USB, registered trademark). Further examples of the control network 122 include various wireless networks such as Bluetooth (registered trademark).

Examples of an upper protocol in a protocol stack include an OPC unified architecture (UA), a data distribution service (DDS), and a communication protocol based on a service based interface (SBI). Alternatively, examples of the upper protocol include REST API, HTTP/2, openAPI, JavaScript object notation (JSON) data, and IEC61850. Alternatively, the above-described protocol may be hierarchized. For example, a content of a data area on TSN applies an OPC UA standard.

In the specification, an example in which EtherCAT is used as the control network 122 will be described. The EtherCAT network has the following features (1) to (3).
(1) The control device 120 called a master is connected to a single or a plurality of control target devices (also simply referred to as devices) 121 called slaves. A control packet transmitted from the control device 120, specifically, a communication frame including a control packet, returns to the control device 120 in order of one or more control target devices 121. For example, a topology includes a line topology, a ring topology, and a star topology. A relay device adapted to the EtherCAT is used as necessary.
(2) One control packet may contain control data, specifically datagrams, for each of a plurality of control target devices 121. Accordingly, the control device 120 only needs to transmit and receive a smaller number of packets than a case in which the control device 120 individually transmits packets to and receiving packets from a plurality of control target devices 121.
(3) The control packet includes a control command indicating an access content to each of the plurality of control target devices 121. When the control packet is transmitted from the control device 120, the control packet is sequentially transferred to the control target devices 121 according to a connection order with a network, and then returns to the control device 120 which is a transmission source.

The control system configuration device 124 is a device that sets a configuration of the control system 123, and is also called a configurator, for example. The setting includes, for example, a setting of parameters and operation modes in the control device 120 and the control target device 121. Alternatively, the setting includes an address assignment when the control target device 121 is mapped to a logical address, in other words, a virtual area, and a setting of the control target device 121 related to such a setting of the logical address.

In such a setting, a datagram for setting may be determined by the control system configuration device 124, the determined information may be transferred to the control device 120, and the control device 120 may transmit the information to the control target device 121. These settings may be performed by generating, editing, and managing EtherCAT slave information (ESI) and EtherCAT network information (ENI) in EtherCAT.

In this manner, when the control system configuration device 124 is used to set the control system 123, not only a setting in an online state in which the control system 123 is operated, but also a setting in an offline state before the control system 123 is operated may be used. In such a case, a connection between the control system configuration device 124 and the control device 120 or a connection between the control system configuration device 124 and the control target device 121 may be performed only during setting. Alternatively, the control system configuration device 124 may be directly connected to the control target device 121 without passing through the control device 120.

The connection here includes not only a physical connection using the control network 122 or a network cable but also a logical connection such as a communication protocol and software for setting. Examples of such a connection include a USB cable, a connection based on a joint test action group (JTAG) specification, and a connection by wireless communication such as a wireless LAN.

In addition, the control system configuration device 124 may not physically connect the control system 123, the control device 120, and the control target device 121, and may store an output or generated data in a removable external storage media. In this case, the output or the generated data is transmitted by attaching the external storage media to a target device such as the control device 120 or the control target device 121. Examples of such an external storage media include a USB memory, a CD, a DVD, a Blu-ray (registered trademark), a compact flash, and a floppy disk (FD).

The control system configuration device 124 may be implemented in a similar manner to the control device 120. The control system configuration device 124 may be connected to the control device 120 via the control network 122 or may be connected to the control device 120 via a network independent of the control network 122.

The control system management device 125 is a device that is connected to the control device 120 and controls and manages the control device 120. For example, the control system management device 125 sets and acquires a control parameter, a control policy, and the like for the control device 120 to perform control. In addition, the control system management device 125 may perform functional division on the control device 120 from the viewpoint of time resolution. That is, the control system management device 125 can control a control parameter, a target value, and the like of the control device 120 in a relatively long control period for a control period executed by the control device 120. In another aspect, while the control device 120 perform automatic control, the control system management device 125 can enable a system operator to perform manual control.

The control system management device 125 may be implemented in a similar manner to the control device 120. The control system management device 125 may be connected to the control device 120 via the control network 122 or may be connected to the control device 120 via a network independent of the control network 122.

In addition to the system shown as the control system 123 in FIG. 1, an example is shown in which an IoT system or the like that analyzes the information collected via the control network 122 using artificial intelligence or the like on a cloud or the control system management device 125 and applies diagnosis technology such as performance improvement or prevention maintenance of the control system is added to the control system. These forms may include a connection form using a wireless such as 5G or a public network to connect the control system 123 to a host system.

### Hardware Structure of Control Device 120

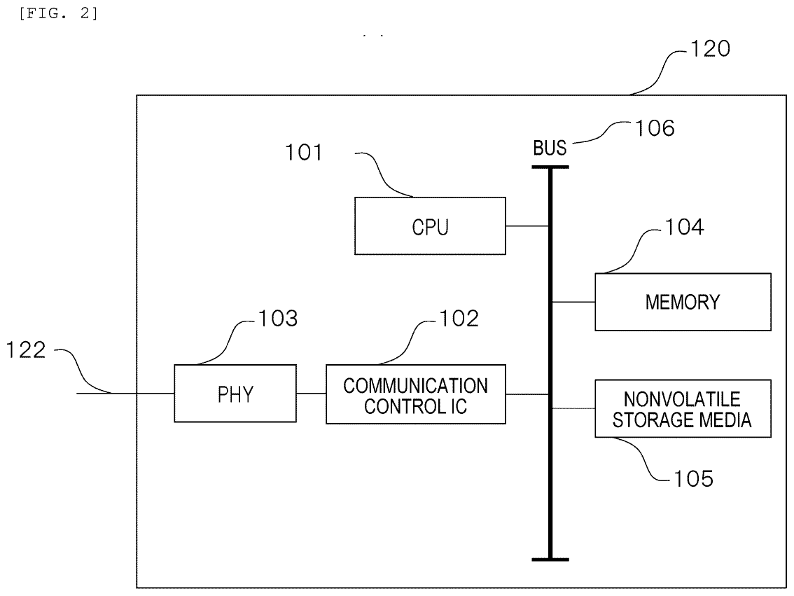

FIG. 2 is a block diagram showing a hardware structure example of the control device 120 shown in FIG. 1. In FIG. 2, a CPU 101, which is an example of a processor, transfers a program and software from the nonvolatile storage media 105 to the memory 104 and executes the program. Examples of an execution processing program include an operating system (hereinafter, referred to as an OS) and an application program operating on an OS. Based on such a program, the CPU 101 executes an operation setting for a communication control IC 102, acquisition of state information in the communication control IC 102, and the like.

The communication control IC 102 receives a transmission request and transmission data from the CPU 101 which operates based on software, and transmits the data to the control network 122 using a PHY 103. The communication control IC 102 transfers data received from the control network 122 via the PHY 103 to the CPU 101, a memory 104, and a nonvolatile storage media 105 via a bus 106.

Implementation examples of the communication control IC 102 include an IC such as a field programmable gate array (FPGA), a complex programmable logic device (CPLD), an application specific integrated circuit (ASIC), and a gate array. Alternatively, the communication control IC 102 may be integrated with the CPU 101.

The communication control IC 102 may be implemented as an IEEE 802.3 communication device including a MAC layer and a PHY layer, and the communication control IC 102 may include a PHY function, that is, the PHY 103. In this case, implementation examples of the communication control IC 102 include a media access control (MAC) chip of IEEE 802.3 standard, a physical layer (PHY) chip, and a composite chip of MAC and PHY. The communication control IC 102 may be included in the CPU 101 or a chip set that controls an information path inside a computer. Although one communication control IC 102 is shown in the configuration in FIG. 2, the number of the communication control ICs 102 may be plural.

The PHY 103 is a transceiver IC that implements a function for communicating with the control network 122. Examples of a communication standard provided by the PHY 103 include a physical layer (PHY) chip of IEEE 802.3. In the configuration example of FIG. 2, the PHY 103 and the communication control IC 102 are connected, and the processing of the MAC layer of IEEE802.3 is included in the communication control IC 102. However, the configuration may also be a configuration in which an IC that provides a MAC function is placed between the communication control IC 102 and the PHY 103 or a configuration in which a communication IC in which an IC that provides a MAC function and the PHY 103 are combined is connected to the communication control IC 102. A quantity relationship between the communication control IC 102 and the PHY 103 may be a relationship in which one or more PHYS 103 are provided for one communication control IC 102.

The memory 104 is a temporary storage area for operating the CPU 101, and stores an OS, an application program, and the like transferred from the nonvolatile storage media 105. The nonvolatile storage media 105 is a storage media for information, and is used to store an OS, an application, a device driver, and a program for operating the CPU 101, or to store a result of program execution. Examples of the nonvolatile storage media 105 include a hard disk drive (HDD), a solid state drive (SSD), and a flash memory. Examples of an external storage media that can be easily removed include a floppy disk (FD), a CD, a DVD, a Blu-ray (registered trademark), a USB memory, and a compact flash.

The bus 106 connects the CPU 101, the communication control IC 102, the memory 104, and the nonvolatile storage media 105. Examples of the bus 106 include a PCI bus, an ISA bus, a PCI Express bus, an on-chip bus, a system bus, and a memory bus.

### Functional Configuration of Control Device 120

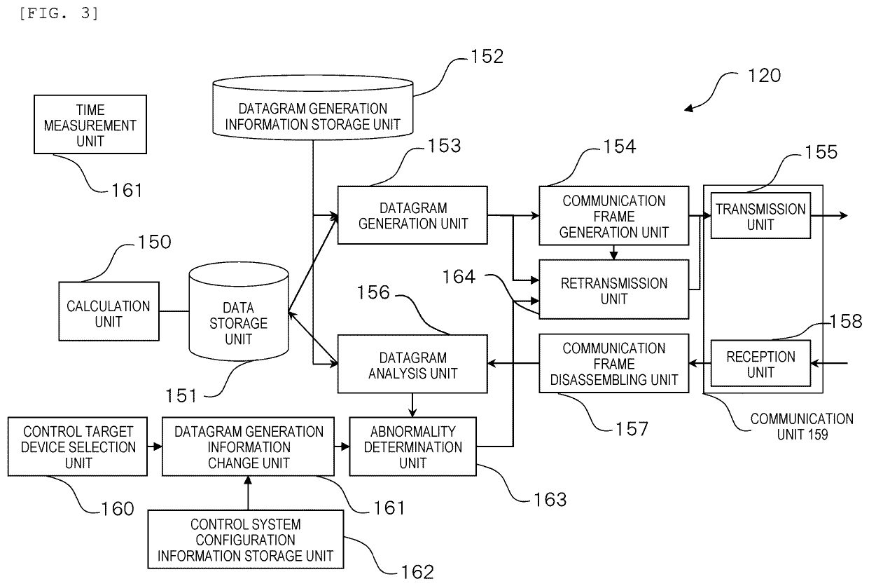

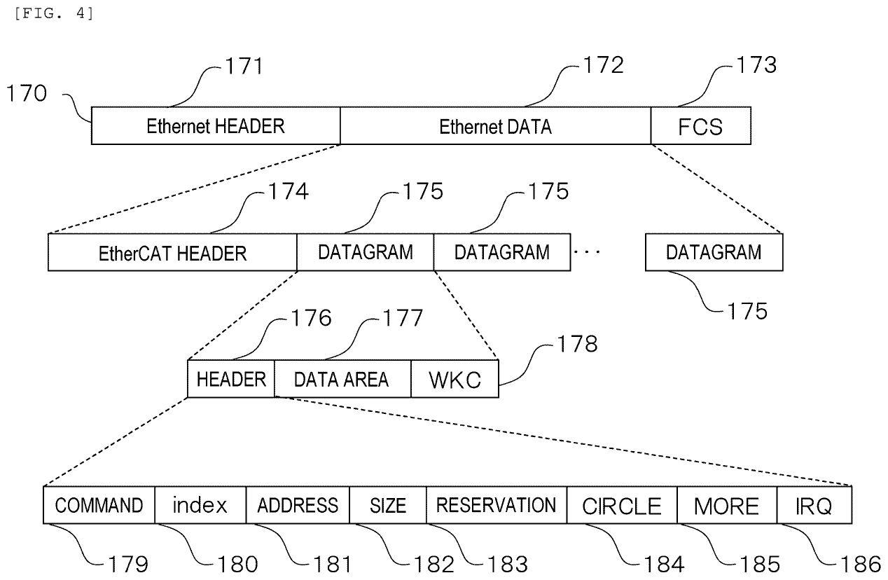

FIG. 3 is a functional block diagram showing a functional configuration example of the control device 120 shown in FIG. 1. FIG. 4 is a diagram showing a configuration example of an EtherCAT frame transmitted on the control network 122 shown in FIG. 1. In FIG. 3, a calculation unit 150 performs control calculation, an information processing calculation, and the like. As an example of such a calculation, the calculation unit 150 processes sensor information received from the control target device 121, and derives a control command for driving the control target device 121 based on a predetermined control law. Alternatively, the calculation unit 150 performs filtering processing or statistical processing on the sensor values, or statistical processing on a set of sensor values over a predetermined cycle in the past.

Specific calculation contents of the calculation unit 150 include a control calculation based on a control engineering theory called feedback control or feedforward control, and a control calculation using AI. Examples of the calculation contents include a control calculation that can change a state depending on past information, such as integral (I) control and control using a state machine. Alternatively, examples of the calculation contents include a statistical control calculation such as AI and machine learning processing for the purpose of state management (detection of a failure or a dangerous state) of the control target device 121, device management or asset management (version management, update, or the like of software), prevention maintenance, conditions based maintenance (CBM), and remaining life prediction.

As a more specific calculation content of the calculation unit 150, if the control target device 121 is a mobile object, examples thereof include a control calculation such as determination of a moving direction or a target movement position, speed control, acceleration control, stop, and deceleration. When the control target device 121 is an industrial robot arm, examples of the calculation contents include a calculation of o a control command for a motor of each articulated joint, control of a tip position of a robot arm, or a control calculation such as trajectory control of the robot arm.

The control target device 121 is of various types, and may be a simple sensor as well as an actuator. Therefore, the calculation unit 150 executes control according to the type of the control target device 121. The calculation unit 150 is, for example, implemented by the CPU 101 or an application operating on the CPU 101.

A data storage unit 151 is a functional unit that stores data to be communicated. The content of the data storage unit 151 is updated by the calculation unit 150 and a datagram analysis unit 156. The data storage unit 151 stores data generated by the calculation unit 150 when executing predetermined control and information processing for an individual or a plurality of control target devices 121.

As a specific example, first, reception data during reception is stored in the data storage unit 151 by the datagram analysis unit 156. The data thus stored is acquired by the calculation unit 150 or a datagram generation unit 153. The calculation unit 150 extracts data from the data storage unit 151 to acquire sensor information and the like. The datagram generation unit 153 extracts data from the data storage unit 151 to generate a datagram. The extracted data corresponds to, for example, a data area 177 in FIG. 4.

When a plurality of datagrams are generated by the datagram generation unit 153, the data storage unit 151 aggregates and stores a plurality of data portions of a datagram group. The data storage unit 151 may manage data in units of a communication period or a control period determined by the control and the information processing executed by the calculation unit 150 and the control target device 121. For example, the data storage unit 151 is implemented by any one of the memory 104 or the nonvolatile storage media 105, or a plurality thereof.

A datagram generation information storage unit 152 stores datagram generation information required for generating a datagram by the datagram generation unit 153, that is, communication control information. For example, the datagram generation information storage unit 152 is implemented by any one of the CPU 101, the memory 104, and the nonvolatile storage media 105, or a plurality thereof. The datagram generation information may be, for example, any one or a plurality of pieces of the following information (1) to (8).
(1) Information constituting a header of a datagram

For example, in the case of the EtherCAT frame shown in FIG. 4, in other words, the control packet, a command 179, an index 180, an address 181, a size 182, a CIRCLE 184, and a MORE 185 are shown. Since an IRQ 186 is mainly an event notification from a control target device 121 side, whether the IRQ 186 is included in the datagram generation information is freely set.
(2) Information on a communication frame generation unit 154 which is a transfer destination of the generated datagram

A plurality of communication frame generation units 154 may be provided.
(3) Information on a communication period
(4) Information on a start time

The start time may be either a relative time or an absolute time.
(5) Information of an expected value of a verification code (a verification parameter)

The information corresponds to a WKC 178 in the case of the EtherCAT frame shown in FIG. 4. By comparing a value of the WKC 178 with the expected value during reception, it is possible to verify whether a target datagram is processed as assumed. Since the WKC 178 is mainly used during reception, the WKC 178 may not be used at the time of transmission.
(6) Information of a transmission target status in a predetermined state machine

The information is information for controlling whether the datagram is a transmission target for the purpose of switching a set of datagram serving as transmission targets. The information may be a truth value simply referred to as whether to transmit the information.
(7) Transmission pattern information

The information is pattern information indicating whether to transmit a target datagram for each communication period.
(8) Information on validity/invalidity of datagram generation information

For example, when some of the devices are invalidated for reasons such as maintenance and cleaning, it is not necessary to generate and transmit a datagram to the device. Therefore, it is possible to invalidate the corresponding datagram generation information based on the information.

The datagram generation unit 153 extracts information required for generating a datagram from the datagram generation information storage unit 152. The extracted datagram generation information includes a data position on the data storage unit 151, and the datagram generation unit 153 extracts data from the data storage unit 151 based on the data position. The datagram generation unit 153 generates a datagram (control data) from the extracted data and datagram generation information (communication control information), and transfers the datagram (the control data) to the communication frame generation unit 154. For example, the datagram generation unit 153 is implemented by any one of the CPU 101 or an application operating on the CPU 101, and the communication control IC 102, or a plurality thereof.

The communication frame generation unit 154 shapes the datagram generated by the datagram generation unit 153 into a communication frame (for example, an EtherCAT frame in the case of an EtherCAT standard). The communication frame generation unit 154 may use a plurality of datagrams to construct a communication frame. The communication frame generation unit 154 stores or calculates and adds, for example, header information and tail information required for constructing a communication frame. For example, in the case of the EtherCAT standard, the information corresponds to an Ethernet header 171 and a frame check sequence (FCS) 173.

The communication frame generation unit 154 transfers the constructed communication frame to a transmission unit 155. For example, the communication frame generation unit 154 is implemented by any one of the CPU 101 or an application operating on the CPU 101, the communication control IC 102, and the PHY 103, or a plurality thereof. The transmission unit 155 is a transmission functional unit, and transmits a packet from the control device 120 to the control network 122. For example, the transmission unit 155 is implemented by any one of the communication control IC 102 and the PHY 103, or a plurality thereof.

The datagram analysis unit 156 analyzes the datagrams transferred from a communication frame disassembling unit 157 and updates the data storage unit 151 according to received contents. For example, the datagram analysis unit 156 is implemented by any one of the CPU 101 or an application operating on the CPU 101, the communication control IC 102, and the PHY 103, or a plurality thereof.

The communication frame disassembling unit 157 receives a received frame transferred from a reception unit 158, removes header and tail information, and disassembles the received frame on a datagram basis. The communication frame disassembling unit 157 transfers the disassembled datagrams to the datagram analysis unit 156. For example, the communication frame disassembling unit 157 is implemented by any one of the CPU 101 or an application operating on the CPU 101, the communication control IC 102, and the PHY 103, or a plurality thereof.

The reception unit 158 is a receiving functional unit, and receives a packet from the control network 122. The reception unit 158 may verify a frame check sequence (FCS) and determine validity of the received packet, or may discard a received packet that is determined as abnormal. For example, the reception unit 158 is implemented by any one of the communication control IC 102 and the PHY 103, or a plurality thereof.

The communication unit 159 is a functional unit that is connected to the control network 122 and is constituted to perform communication according to a communication protocol of the control network 122, and includes the transmission unit (in other words, a communication port) 155 and the reception unit (in other words, a communication port) 158. In the configuration example shown in FIG. 2, since the PHY 103 is outside the communication control IC 102, a communication unit 159 corresponds to a processing unit of a MAC layer. Alternatively, the communication control IC 102 may be an Ethernet communication device including a MAC layer and a PHY layer, or the communication control IC 102 may include a PHY function. For example, the communication unit 159 is implemented by any one of the communication control IC 102 and the PHY 103, or a plurality thereof.

A control target device selection unit 160 selects the control target device 121 in order to temporarily add, stop, invalidate or remove the control target device 121 due to, for example, maintenance, planned shutdown or the like. The control target device selection unit 160 transmits a selected identifier of the control target device 121 to a datagram generation information change unit 161. The control target device selection unit 160 may transmit, to the datagram generation information change unit 161, not only the identifier of the control target device 121 but also the information related to the control target device 121.

Examples of the information related to the control target device 121 include performance and specifications of the control target device 121, and connection positions and target periods in the control network 122. The connection position represents a connection position in a case in which the selected control target device 121 is newly added, and a connection position in a case in which the selected control target device 121 is removed. The target period indicates a period in which the selected control target device 121 is stopped or a period in which the selected control target device 121 is valid.

A plurality of control target devices 121 to be selected may be provided. The processing for the selected control target device 121 is, for example, any one of addition, stop, invalidation, and removal, and may be different from each other. Examples of specific processing contents for the control target device 121 include a case in which the control target device 121 is physically removed from the control system 123, a case in which the control target device 121 is functionally stopped while being connected to the control network 122 (for example, a power supply stop), a case in which the packet is not processed while the energization is maintained, and a case in which an instruction from the control device 120 is ignored.

The control target device selection unit 160 is implemented by any one of the CPU 101 or an application operating on the CPU 101, the communication control IC 102, and the PHY 103, or a plurality thereof. Alternatively, the control target device selection unit 160 may be implemented by constituting a human machine interface (HMI) such as a graphical user interface (GUI) by the control system management device 125.

In this case, an operator operates the HMI of the control system management device 125 to select the control target device 121, and the control system management device 125 notifies the control device 120 of a result. Attached information (the function, the specification, the connection position, and the like of the control target device 121) of the selected control target device 121 may be transmitted to the control device 120 in advance by being stored by the control system management device 125. Alternatively, only the identifier information of the control target device 121 may be notified from the control system management device 125 to the control device 120, and the attached information may be selected from the notified identifier of the control target device 121 in the control device 120. In this case, the attached information of the control target device 121 is stored in the control system configuration information storage unit 162.

The datagram generation information change unit 161 acquires related information from the control system configuration information storage unit 162 based on the information of the control target device 121 notified by the control target device selection unit 160, and changes the datagram generation information stored in the datagram generation information storage unit 152. For example, the datagram generation information change unit 161 is implemented by the CPU 101 or an application operating on the CPU 101.

The control system configuration information storage unit 162 stores control system configuration information of the control system 123. Examples of the control system configuration information include any or all of associations between the control target device 121, the datagram generation information stored in the datagram generation information storage unit 152, and a logical address, in other words, virtual area assignment information. For example, information such as which datagram generation information, that is, which datagram, corresponds to communication to a certain control target device 121, and which logical address the datagram is addressed to, is exemplified. These are not limited to one-to-one correspondence, and may be one-to-plural or plural-to-plural correspondence relationships.

That is, for example, with regard to the plural-to-plural correspondence, there may be a plurality of datagrams to be communicated to a certain control target device 121, while there may also be a plurality of control target devices 121 to which a certain datagram is to be communicated. The same applies to a correspondence relationship between the control target device 121 and the assignments of the logical addresses, an input and output area of a certain control target device 121 may be assigned to a plurality of logical address areas, while a certain logical address area may contain a plurality of control target devices 121.

Here, one logical address area is, for example, an area assigned to a continuous address space, and is an area managed by one fieldbus memory management unit (FMMU) in an example of EtherCAT. When the same logical address is designated in the FMMU of different control target devices 121, a plurality of control target devices 121 can be associated with the same logical address. The control system configuration information is not limited to the logical address, and may include an auto-increment address and a station address corresponding to each control target device 121.

For example, the control system configuration information storage unit 162 is implemented by any one of the CPU 101, the memory 104, and the nonvolatile storage media 105, or a plurality thereof. Examples of the control system configuration information include a database on software, a file format such as comma separated values (CSV), extensible markup language (XML), or javascript object notation (JSON), a structure which is instantiated on software and is in a predetermined programming language, or an object.

The abnormality determination unit 163 determines an abnormality based on any one or a plurality of information about the received communication frame, a content of the reception datagram transferred from the communication frame disassembling unit 157, a received timing, information stored in the datagram generation information storage unit 152, and a setting from the system operator. When determination is performed based on the information related to the communication frame, the information may be extracted and notified to the datagram analysis unit 156 in the communication frame disassembling unit 157. When determination is performed based on the reception datagram, the determination may be made collectively for a plurality of reception datagrams constituting the communication frame.

Specifically, the abnormality determination unit 163 determines that an abnormality occurs when any one or a plurality of the following criteria are satisfied.
a) The WKC 178 of the received datagram differs from an expected value that is predetermined based on a configuration plan and settings of the control system 123.
b) An elapsed time from the transmission to the reception of the target communication frame or the datagram exceeds a predetermined value.
c) An error is detected in the FCS 173 of the received communication frame.
d) The datagram number that is not consistent with the expected value of the WKC 178 in a) is equal to or greater than a predetermined number.
e) A ratio of the datagram number that is not consistent with the expected value of the WKC 178 in a) to the total number of reception datagrams that constitute the communication frame is equal to or greater than a predetermined value.

When a plurality of conditions are considered, it may be determined by a logical expression defined under each condition. For example, d & e (d and e) is used. In addition, the expected value of the WKC 178 in a) is, for example, stored as being included in the datagram generation information.

Here, examples of a transmission timing in b) are as follows.
A timing at which the datagram generation unit 153 starts generating a datagram.
A timing at which the communication frame generation unit 154 starts generating a communication frame.
A timing at which a first datagram is transferred from the datagram generation unit 153 to the communication frame generation unit 154.
A timing at which a last datagram is transferred from the datagram generation unit 153 to the communication frame generation unit 154.
A timing at which a head of the communication frame is transferred from the communication frame generation unit 154 to the transmission unit 155.
A timing at which a tail of the communication frame is transferred from the communication frame generation unit 154 to the transmission unit 155.
A timing at which the head of the communication frame is sent from the transmission unit 155.
A timing at which the tail of the communication frame is sent from the transmission unit 155.

On the other hand, examples of a reception timing in b) are as follows.
A timing at which the datagram analysis unit 156 starts analysis of a datagram.
A timing at which the communication frame disassembling unit 157 starts disassembling of the communication frame.
A timing at which the datagram analysis unit 156 completes the analysis of the first datagram.
A timing at which the datagram analysis unit 156 completes the analysis of the last datagram.
A timing at which the head of the communication frame is transferred from the reception unit 158 to the communication frame disassembling unit 157.
A timing at which the tail of the communication frame is transferred from the reception unit 158 to the communication frame disassembling unit 157.
A timing at which the reception unit 158 receives the head of the communication frame.
A timing at which the reception unit 158 receives the tail of the communication frame.

At the reception timing of b), the abnormality determination unit 163 may verify the FCS 173 and determine that the received communication frame is received after confirming that there is no problem with the received communication frame. The abnormality determination unit 163 may notify an external device when the abnormality is determined. Examples of a notification unit to the outside include notification to an external device such as the control system management device 125, presentation by a visual unit using HMI or the like, and presentation by an LED on the control device 120. For example, the abnormality determination unit 163 is implemented by any one of the CPU 101 or an application operating on the CPU 101, the communication control IC 102, and the PHY 103, or a plurality thereof.

A retransmission unit 164 retransmits the communication frame when the abnormality determination unit 163 determines that there is an abnormality. For the retransmission, the retransmission unit 164 stores the communication frame transmitted from the communication frame generation unit 154 to the transmission unit 155 and the datagram transmitted from the datagram generation unit 153 to the communication frame generation unit 154. When the occurred abnormality is on a datagram basis (for example, an inconsistency with in the expected value of the WKC 178), the retransmission unit 164 may constitute the communication frame only with the corresponding datagram and retransmit the communication frame, or may retransmit the entire communication frame including the corresponding datagram.

Although the retransmission unit 164 is implemented as an independent functional unit in FIG. 3, the retransmission unit 164 may not be provided, and the datagram generation unit 153 or the communication frame generation unit 154 may have a retransmission function, and may retransmit based on a notification of abnormality determination from the abnormality determination unit 163. The datagram generation unit 153 and the communication frame generation unit 154 are connected to the retransmission unit 164. Alternatively, the retransmission unit 164 may independently access the datagram generation information storage unit 152 in the same manner as the datagram generation unit 153 to generate a datagram.

The retransmission unit 164 may have a function of validating and invalidating, and may retransmit only when the abnormality determination unit 163 is validated and receives a notification of abnormality determination. A timing of retransmission by the retransmission unit 164 may be a timing at which the abnormality determination is notified from the abnormality determination unit 163, or may be retransmitted after a predetermined time elapses. Alternatively, after the abnormality determination unit 163 is notified of the abnormality determination, the retransmission unit 164 may retransmit the communication frame or the datagram in which the abnormality occurs after a predetermined time elapses from a transmission timing of them in any one of the datagram generation unit 153, the communication frame generation unit 154, and the transmission unit 155. For example, the retransmission unit 164 is implemented by any one of the CPU 101 or an application operating on the CPU 101, the communication control IC 102, and the PHY 103, or a plurality thereof.

A time measurement unit 165 is a functional unit that manages an elapsed time. The time measurement unit 165 measures an elapsed time of an event in each functional unit or between functional units shown in FIG. 3, and measures an occurrence time of a specific event. A time in this case may be an absolute time based on a global positioning system (GPS) or the like, a time of the control device 120, or a synchronized time based on a reference time in the control system 123. For example, in EtherCAT, a configuration is shown in which, among the control target devices 121, the control target device 121 that supports a distributed clock protocol (DC) and is closest to the control device 120 is set as a reference time.

Events to be measured by the time measurement unit 165 include a predetermined communication frame, a transmission time and a reception time of a datagram, a data transfer time between functional units, and a data processing time or a data storage period within the functional unit. Alternatively, the time measurement unit 165 may generate an interrupt when a designated time elapses or when a designated time is reached, and notify other functional unit of the interrupt. At this time, the time measurement unit 165 may periodically generate and notify the interrupt. An implementation example of the time measurement unit 165 includes a time measurement device (a crystal oscillator or a timer device) of the CPU 101 or the communication control IC 102, and the memory 104 or the nonvolatile storage media 105 may be used as a storage unit of a measured time.

Although one transmission unit 155 and one reception unit 158 are shown in FIG. 3, when a plurality of communication control ICs 102 and a plurality of PHYS 103 are provided, a plurality of transmission units 155 and a plurality of reception units 158 may be provided. When a plurality of transmission units 155 are included, the datagram generation unit 153 and the communication frame generation unit 154 may be provided for each transmission unit 155. The communication frame may be transferred from one communication frame generation unit 154 to the plurality of transmission units 155, or the datagram may be transferred from one datagram generation unit 153 to the plurality of communication frame generation units 154.

In this case, when a datagram is transferred from the datagram generation unit 153 to the communication frame generation unit 154, the datagram generation unit 153 may transfer information indicating to which transmission unit 155 a communication frame including the datagram is to be transferred. Alternatively, the datagram generation information of the datagram generation information storage unit 152 may include an identifier of the transmission unit 155 that transmits the datagram, and the communication frame generation unit 154 may confirm the datagram generation information of the datagram generation information storage unit 152. At this time, based on the transmission from the plurality of transmission units 155, the number of identifiers of the transmission units 155 included in the datagram generation information may be plural.

Similarly, when a plurality of reception units 158 are included, the datagram analysis unit 156 and the communication frame disassembling unit 157 may be provided for each reception unit 158. The communication frame may be transferred from the plurality of reception units 158 to one communication frame disassembling unit 157, or the datagram may be transferred from the plurality of communication frame disassembling units 157 to one datagram analysis unit 156. In this case, for example, the communication frame disassembling unit 157 may be that, when transferring a datagram to the datagram analysis unit 156, it also transfers information regarding from which the reception unit 158 the communication frame including the datagram is transferred.

### Hardware Structure of Control Target Device 121

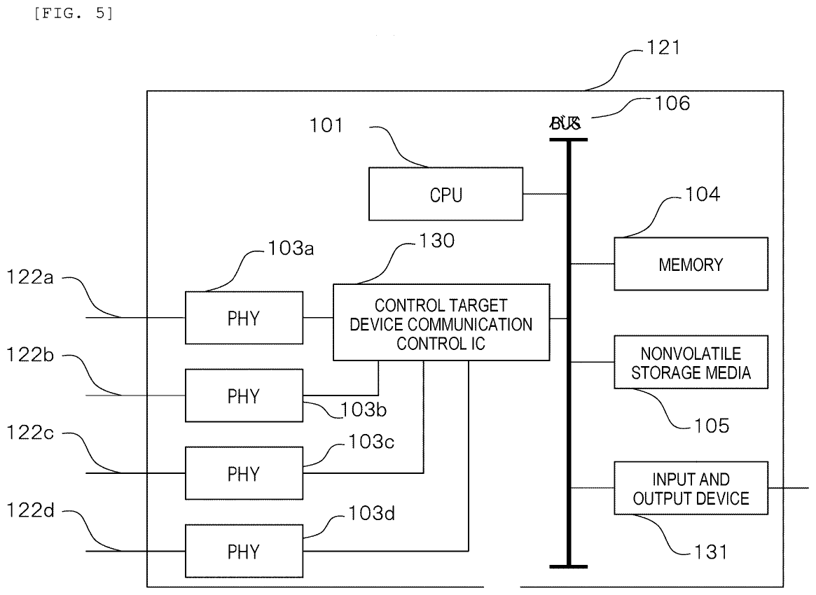

FIG. 5 is a block diagram showing a hardware structure example of the control target device 121 shown in FIG. 1. Here, the control target device 121 conforming to a EtherCAT specification defined by a communication profile family 12 of IEC 61158 and IEC 61784 Part 2 will be described as an example. However, the control target device 121 according to the embodiment is not limited to the EtherCAT specification.

In FIG. 5, the CPU 101 controls a control target device communication control IC 130 via the bus 106. A peripheral device may be connected to the CPU 101, and the CPU 101 may control a sensor and an actuator via the peripheral device (not shown). The control target device communication control IC 130 communicates with the control network 122 via a plurality of PHYS 103. The control target device communication control IC 130 is a dedicated IC conforming to an EtherCAT specification defined by a communication profile family 12 of IEC 61158 and IEC 61784 Part 2.

The control target device communication control IC 130 may use the nonvolatile storage media 105 when storing and referring to information required for communication. Although the control target device communication control IC 130 is connected to the CPU 101 via the bus 106, the control target device communication control IC 130 may be directly connected to the CPU 101 using a dedicated bus. One or both of the memory 104 and the nonvolatile storage media 105 dedicated to the control target device communication control IC 130 may be separately provided to store information required for processing of the control target device communication control IC 130.

An input and output device 131 is an input and output interface for acquiring sensor values from sensors constituting the control target device 121 and for controlling actuators constituting the control target device 121. Examples of the input and output device 131 include various actuators such as a motor, various sensors (encoders, temperature sensors, pressure sensors, image sensors, cameras, and the like), various digital input and output ICs and analog input and output ICs, and a driver IC.

Although one signal line from the input and output device 131 is shown here, a plurality of signal lines may be provided according to the configuration of the control target device 121. A plurality of input and output device 131 may be provided. The input and output device 131 may only input information to a connected sensor, may only output information to a connected actuator, or may have both input and output functions. Any one or more of the CPU 101, the memory 104, and the nonvolatile storage media 105 may be included in the control target device communication control IC 130 to form a one-chip communication control IC.

### Functional Configuration of Control Target Device Communication Control IC 130

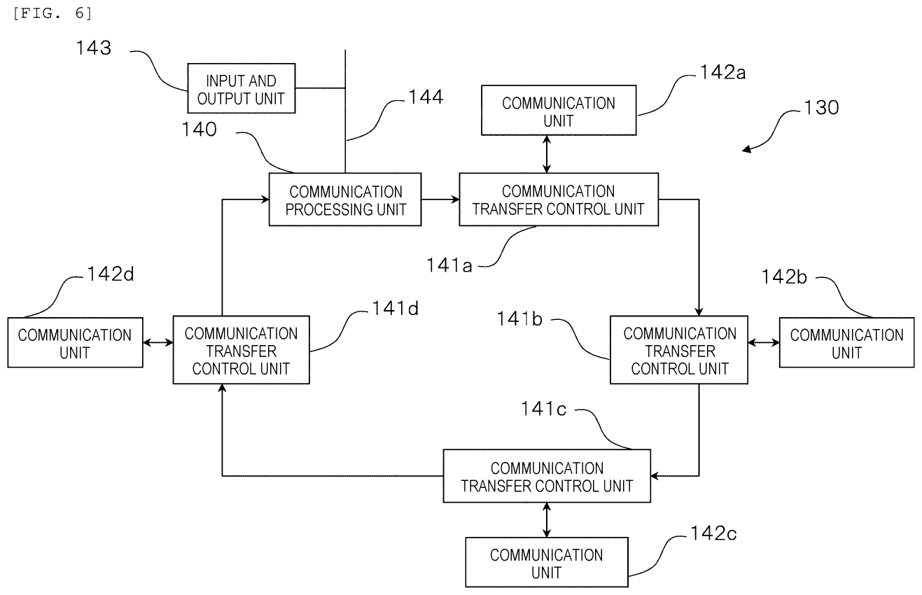

FIG. 6 is a block diagram showing a functional configuration example of the control target device communication control IC 130 shown in FIG. 5. In FIG. 6, four sets of communication port functions according to a combination of a communication transfer control unit 141 and a communication unit 142 are provided, for example. A communication processing unit 140 is connected between a communication transfer control unit 141a and a communication transfer control unit 141d related to two communication port functions. For example, the communication processing unit 140 is an IC that executes communication processing conforming to the EtherCAT specification, and is implemented by an EtherCAT processor unit (EPU) The communication processing unit 140 may be connected to other calculation functions and input and output functions (not shown).

The communication transfer control unit 141 is a functional unit that transfers a received packet to the adjacent communication transfer control unit 141 or the communication unit 142. A transfer direction between the communication transfer control units 141 is constant in the control target device communication control IC 130, and for example, a packet is transferred in order of the communication transfer control units 141a, 141b, 141c, and 141d. In addition, the communication transfer control unit 141 transfers a packet to the communication unit 142 or transfers a packet to the adjacent communication transfer control unit 141 based on a setting from the communication processing unit 140 and a connection state of a communication path to which the communication unit 142 is connected.

The communication unit 142 is a functional unit that is connected to the control network 122 and performs communication according to the communication protocol of the control network 122. The communication unit 142 includes a transmission unit 167 and a reception unit 168. For example, the communication unit 142 is implemented by any one the control target device communication control IC 130 or the PHY 103, or a plurality thereof.

An input and output unit 143 is an input and output function for acquiring sensor values from sensors constituting the control target device 121 or for controlling actuators constituting the control target device 121. The input and output unit 143 is, for example, implemented by the input and output device 131. A bus 144 is a communication line for connecting to any one or more of the CPU 101, the memory 104, and the nonvolatile storage media 105, and is, for example, implemented by the bus 106 in FIG. 5.

### Functional Configuration of Control System Configuration Device 124

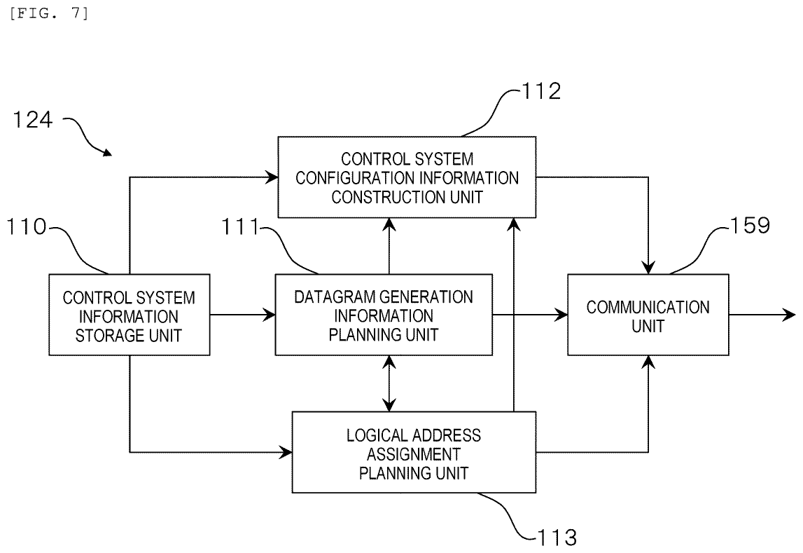

FIG. 7 is a block diagram showing a functional configuration example of the control system configuration device 124 shown in FIG. 1. The hardware structure of the control system configuration device 124 is the same as that of the control device 120 shown in FIG. 2. In FIG. 7, a control system information storage unit 110 stores information on the control system 123. Specifically, examples of the information on the control system 123 include control processing and information processing requests executed on the control system 123, and requests from the control device 120 and the control target device 121. Examples of such requirements include a control period, a communication period, an input and output capacity of the control target device 121, and whether periodic communication is required.

Examples of the information on the control system 123 include the number of control devices 120 and control target devices 121, specifications and performance of a computer resource, communication performance, and a configuration of a communication network. Further examples include a frequency, number of cores, a bit width, and an architecture of the CPU 101, a storage capacity and a communication throughput of the memory 104 and the nonvolatile storage media 105, a transfer throughput of the bus 106, and a communication bandwidth and a connection distance of the control network 122. The computer resource such as a CPU, a memory, and a nonvolatile storage media includes both the control device 120 and the control target device 121.

The information of the control system 123 may include information that depends on the implementation of a communication protocol of the control network 122. For example, in the case of EtherCAT, the correspondence numbers of FMMU and SyncManager in the control target device 121 are exemplified. Further, when the control network 122 includes a relay device, the information of the control system 123 includes a computer resource and communication performance of the relay device, a network topology, and configuration information of the control network 122 (such as a setting of each communication port of the relay device).

The control system information storage unit 110 may be manually input with information to be stored by the system operator or the like, or may dynamically collect information of the control device 120, the control target device 121, and the control network 122 using information collection software or a predetermined communication protocol. Examples of such a communication protocol include a simple network management protocol (SNMP) and an access to a predetermined register (for example, a register indicating a model number of a slave IC) in EtherCAT. For example, the control system information storage unit 110 is implemented any one of the CPU 101, an application operating on the CPU 101, the memory 104, and the nonvolatile storage media 105, or a plurality thereof.

A datagram generation information planning unit 111 determines the datagram generation information to be stored in the datagram generation information storage unit 152 shown in FIG. 3 based on the information stored in the control system information storage unit 110 and an assignment of a logical address space determined by a logical address assignment planning unit 113. Examples of the configuration of the datagram determined by the datagram generation information planning unit 111 include a size of each datagram and parameters on a header (such as a logical address space of an access destination). The logical address space to which a physical address space of a certain control target device 121 is assigned may be accessed not only by a single datagram but also by datagrams divided into a plurality of datagrams. For example, the datagram generation information planning unit 111 is implemented by any one of the CPU 101, an application operating on the CPU 101, the memory 104, and the nonvolatile storage media 105, or a plurality thereof.

A control system configuration information construction unit 112 constructs configuration information of the control system 123 stored in the control system configuration information storage unit 162 shown in FIG. 3. Examples of such configuration information include any or all of the associations between the control target device 121, the datagram generation information, and the assignment information of the logical address. The association is constructed based on one or a plurality of pieces of the datagram generation information planned by the datagram generation information planning unit 111, the information stored in the control system information storage unit 110, and the assignment of the logical address space planned by the logical address assignment planning unit 113. For example, the control system configuration information construction unit 112 is implemented by any one of the CPU 101 or an application operating on the CPU 101, the memory 104, and the nonvolatile storage media 105, or a plurality thereof.

The logical address assignment planning unit 113 plans, based on the information stored in the control system information storage unit 110, an assignment of the address space of each control target device 121 to the logical address space. The logical address space is an address space created by a method for assigning input and output of actuators and sensors to a predetermined address space. In the logical address space, any one data area (that is, physical input and output) of each slave is assigned to a single virtual logical address space. A size and an assignment method of the area can be freely set. For example, the logical address assignment planning unit 113 is implemented by any one of the CPU 101, an application operating on the CPU 101, the memory 104, and the nonvolatile storage media 105, or a plurality thereof.

The plan of the datagram generation information by the datagram generation information planning unit 111 and the plan of the assignment of the logical address space by the logical address assignment planning unit 113 may be executed in order, with either one being executed first. For example, after the logical address assignment planning unit 113 plans the assignment of the logical address space, the assignment information of the logical address space is notified to the datagram generation information planning unit 111. The datagram generation information planning unit 111 plans the datagram generation information based on the notified assignment of logical address space, for example.

Alternatively, the datagram generation information planning unit 111 plans the datagram generation information to satisfy a control requirement and a communication requirement of the control target device 121, and notifies the logical address assignment planning unit 113 of the datagram generation information. The logical address assignment planning unit 113 plans the assignment of the logical address space based on the notified datagram generation information, for example. In this case, the logical address assignment planning unit 113 notifies the datagram generation information planning unit 111 of the determined assignment information of the logical address space again, and the datagram generation information planning unit 111 determines a value of an access destination logical address of the datagram to be accessed in the logical address space.

Alternatively, any one or both of the datagram generation information planning unit 111 and the logical address assignment planning unit 113 may define a constraint condition, a satisfaction condition, and a convergence condition. Planning results may be communicated to each other and planning operations may be repeated until these conditions are satisfied. Examples of the constraint condition include that, in planning the datagram generation information in the datagram generation information planning unit 111, a datagram number to be planned is equal to or less than a predetermined number, and, in the logical address assignment planning unit 113, when an assigned logical address space is divided into areas of consecutive addresses, the number of areas is equal to or less than a predetermined number.

In addition, as an operation example, first, the logical address assignment planning unit 113 plans the assignment of the logical address space and notifies the datagram generation information planning unit 111 of the assignment. Subsequently, when the datagram number cannot be reduced to a predetermined number or less in the notified logical address space, the datagram generation information planning unit 111 requests the logical address assignment planning unit 113 to plan the assignment of the logical address space again. In this manner, the planning operations of the datagram generation information planning unit 111 and the logical address assignment planning unit 113 are repeated until the conditions are satisfied. When the plan does not converge even after a predetermined number of repetitions, the operator or an external device may be notified that the plan fails.

### Operation Step of Control System Configuration Device 124

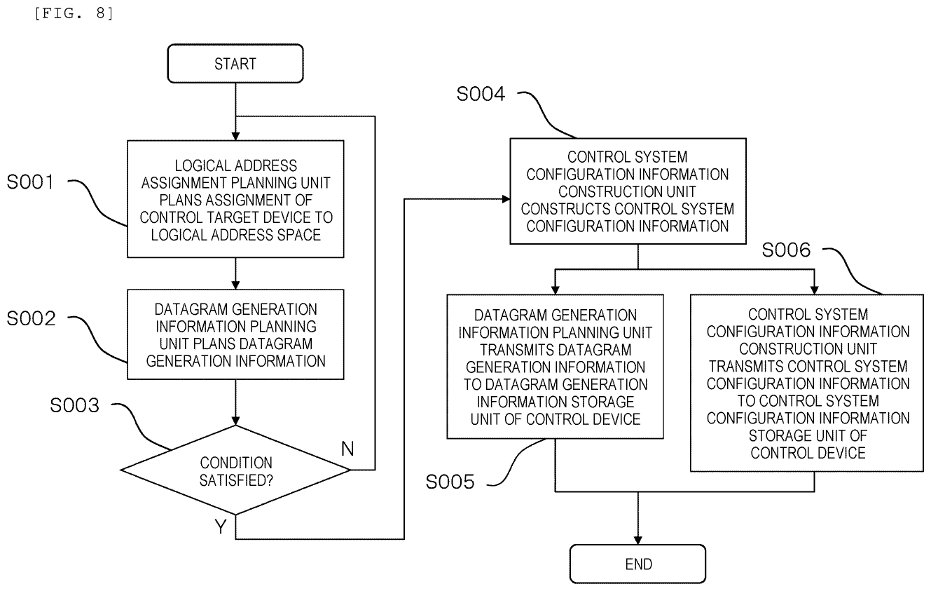

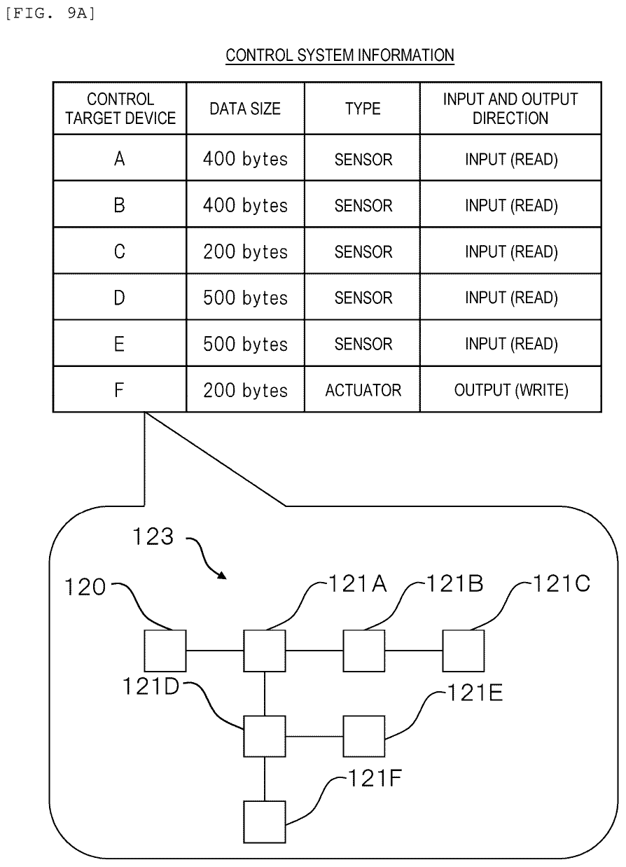

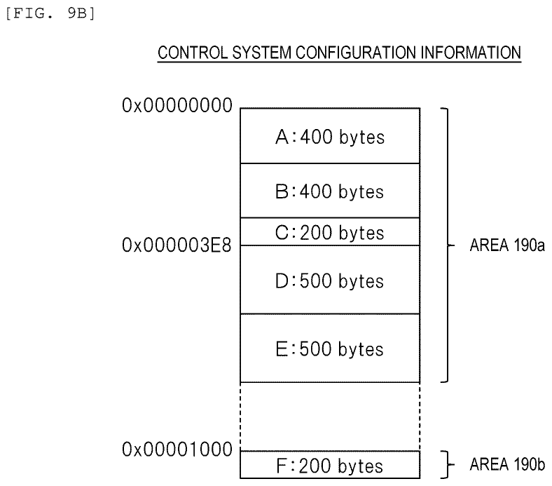

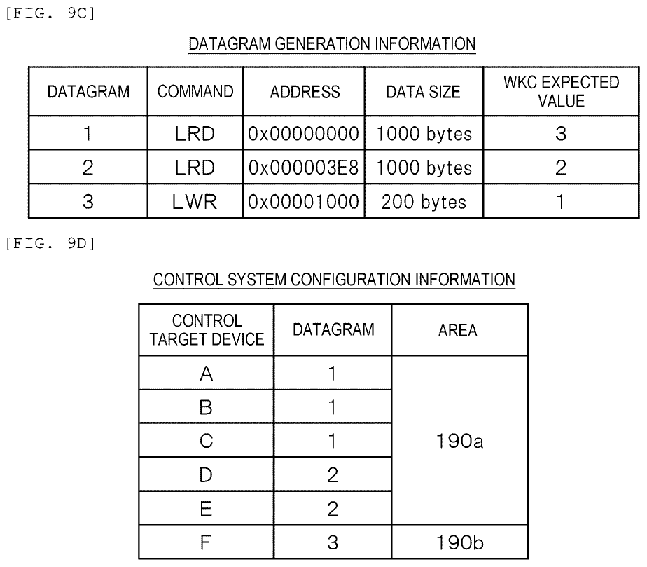

FIG. 8 is a flowchart showing an example of an operation step of each functional unit included in the control system configuration device 124 shown in FIG. 7. FIGS. 9A, 9B, 9C, and 9D are diagrams showing specific examples of the operation step shown in FIG. 8. In FIG. 8, first, the logical address assignment planning unit 113 acquires the information of the control system 123 from the control system information storage unit 110, and plans an assignment of the input and output of each control target device 121 to the logical address space (step S001). As described above, the datagram generation information planning unit 111 and the logical address assignment planning unit 113 can operate independently, FIG. 8 shows an example of an operation in order.

For example, assuming the control system 123 shown in FIG. 9A, the control system information storage unit 110 stores, as the control system information, a size of an input and output space of each of the control target devices 121 (for example, 400 bytes for the control target device 121A), an input and output direction (for example, the control target device 121A is a sensor, and a read access is an input when viewed from the control device 120), and a network topology. For example, the logical address assignment planning unit 113 plans the assignment to the logical address space shown in FIG. 9B from the information. For example, in FIG. 9B, the assignment to the logical address space follows the following steps (1) to (3).
(1) Each control target device 121 is grouped based on the input and output direction.

As a result, the control target devices 121A, 121B, 121C, 121D, and 121E that are input (read) are separated into two groups of the control target device 121F.
(2) An area in the logical address space is assigned to each group.

In FIG. 9B, an area 190a starting from 0x00000000 and an area 190b starting from 0x00001000 are assigned to the respective groups. Although a start address of the area 190b assigned to the second group is set to 0x00001000, a start address may be any value as long as it does not overlap with the area 190a assigned to the first group. For example, the address may be an address continuous to the area 190a.
(3) Within each group divided in (1), each of the control target device 121 is assigned to a logical address space in a connection order to the control device 120.

In FIG. 9B, in the first group, the input and output are assigned in the order of the control target devices 121A, 121B, 121C, 121D, and 121E from the head of the area 190a. Since the second group is only the control target device 121F, the input and output are assigned from the head of the area 190b. As described above, in FIG. 9B, the input and output of the control target device 121 is assigned to the logical address space in consideration of two attributes, which are the input and output direction and the connection order, in order.

Other assignment methods are possible, such as changing the order of grouping and the assignment based on attributes such as a data size and a communication period (not shown in FIG. 9A). The assignment to the logical address space may be determined based on the attributes such as the input and output direction, the connection order, the data size, the communication period, and a device type of the control target device 121. Alternatively, when determining the arrangement on the logical address space, the order of applying each attribute may be changed.

Alternatively, when the control device 120 includes a plurality of communication units 159, the assignment to the logical address space may be determined by the communication unit 159 to which the target control target device 121 is connected. For example, for each control target device 121 group connected to the same communication unit 159, the attributes such as the input and output direction, the connection order, the data size, and the communication period may be assigned to the logical address space in order.

In FIG. 8, next, the datagram generation information planning unit 111 plans the datagram generation information based on the information of the control system 123 stored by the control system information storage unit 110, the assignment information of the logical address space planned by the logical address assignment planning unit 113, and the like (step S002). As an example, the datagram generation information (the communication control information) shown in FIG. 9C is shown.

Here, taking the assignment to the logical address space shown in FIG. 9B as a premise, since the respective areas 190 are grouped based on the input and output direction, the same command can be applied within the area 190. Since the area 190a is an input direction, a datagram of an LRD command which is a read for the logical address can be collected. Similarly, since the area 190b is an output direction, a datagram of an LWR command which is a write to the logical address can be collected.

However, since there is an upper limit to the data size of an Ethernet frame or an EtherCAT datagram, there is a limit to the input and output of the control target device 121 that can be aggregated. In the configuration shown in FIG. 9C, the control target devices 121A, 121B, and 121C are aggregated into a datagram [1]. When only one EtherCAT datagram is stored in the Ethernet frame, the upper limit of the data size is 1486 bytes. A total of the input and output of the control target devices 121A, 121B, and 121C is 1000 bytes (=400 bytes+400 bytes+200 bytes). If the control target device 121D is included, the total becomes 1500 bytes, exceeding the upper limit of 1486 bytes.

Therefore, in the configuration shown in FIG. 9C, the control target devices 121A, 121B, and 121C are aggregated into the datagram [1]. Similarly, the control target devices 121D and 121E are aggregated into a datagram [2]. Both of the datagrams [1] and [2] are LRD commands. In this way, when constructing a datagram, it is necessary to ensure that the data size fits within the upper limit of the communication frame or the datagram.

In the configuration shown in FIG. 9C, the datagram is implemented in units of each control target device 121, and the datagram may be divided into smaller units. That is, the area of the control target device 121D may be divided and included in each of the datagram [1] and the datagram [2]. For example, when including data up to the upper limit, the head 486 bytes (=1486 bytes−1000 bytes) of the input and output of the control target device 121D may be included in the datagram [1], and the remaining 14 bytes (=500 bytes−486 bytes) may be included in the datagram [2]. In the configuration shown in FIG. 9C, the control target device 121F is designated as a datagram [3], and is designated as an LWR command.

The datagram generation information includes an expected value of the WKC 178. The control device 120 transmits a datagram including the WKC 178 to the control network 122. Each control target device 121 processes the received datagram and appropriately updates the value of the WKC 178. Further, the control device 120 receives the datagram in which the value of the WKC 178 is updated in this manner.

The expected value of the WKC 178, which is a verification parameter, is determined based on the number of the control target devices 121 that process the datagram. Since the datagram [1] is addressed to the control target devices 121A, 121B, and 121C, the expected value of the WKC 178 is set to 3. Similarly, since the datagram [2] is addressed to the control target devices 121D and 121E, the expected value of the WKC 178 is set to 2, and since the datagram [3] is addressed to the control target device 121F, the expected value of the WKC 178 is set to 1.

In FIG. 8, after step S002, the control system configuration device 124, for example, the control system configuration information construction unit 112 determines whether the assignment of the logical address space planned by the logical address assignment planning unit 113 and the datagram generation information planned by the datagram generation information planning unit 111 satisfy a predetermined condition (step S003). Examples of such conditions are as below. The control system configuration device 124 may determine a combination of any of the conditions.
Whether the datagram generation information planned by the datagram generation information planning unit 111 is executable is determined.
Is there any overlap between the areas 190 in the logical address space planned by the logical address assignment planning unit 113?
When a search method or an optimization method is applied to the planning of the assignment of the logical address space by the logical address assignment planning unit 113 or the planning of the datagram generation information by the datagram generation information planning unit 111, whether the search method or the optimization method is executed a predetermined number of times. In this case, an optimal plan may be adopted based on, for example, indicators such as minimizing the number of the datagrams or the number of communication frames, or maximizing use efficiency of a communication bandwidth.
Whether indicators such as the number the datagrams or the use efficiency of the communication bandwidth satisfies a predetermined value determined based on the information of the control system is satisfied. For example, an optimum value of the number of the datagrams or the number of the communication frames is determined based on the number of control target devices 121, the input and output direction, and the data size, and whether the number of the datagrams planned by the datagram generation information planning unit 111 is the optimum value is determined.

As the number of the datagrams increases, areas such as the header and the WKC become overhead, reducing the use efficiency of the communication bandwidth, and therefore it is desirable to have a small number of the datagrams. Similarly, as the number of the communication frames increases, the header and an inter-frame gap become overhead and the use efficiency of the communication bandwidth decreases, and therefore it is desirable to have a small number of the communication frames. Further, since the upper limit of the data size in the communication frame or the datagram is determined, if the total data size of input and output of the control target device 121 is determined, theoretically the minimum number of the communication frames or datagrams is determined.

For example, when the total data size of the input and output of the control target device 121 is 2000 bytes, the upper limit of the data size of one datagram is 1486 bytes, and thus the minimum number of the datagrams is 2. Since the upper limit of the data size of an Ethernet frame is also 1498 bytes, the minimum number of the Ethernet frames is also 2. Therefore, since the optimum value for the number of the datagrams is 2, in step S003, for example, it is determined whether the number of the datagrams planned by the datagram generation information planning unit 111 is 2. In step S003, the processing may proceed to step S004 without setting any predetermined condition.

When it is determined in step S003 that the predetermined condition is satisfied (Y in step S003), the control system configuration information construction unit 112 constructs control system configuration information (step S004). An example of the control system configuration information is shown in FIG. 9D. In FIG. 9B, the control target devices 121A, 121B, and 121C are assigned in order from the head to the area 190a of the logical address space, and as shown in FIG. 9C, these are included in datagram [1]. Therefore, in the control system configuration information shown in FIG. 9D, the control target devices 121A, 121B, and 121C are associated with the datagram [1] and the area 190a.

Similarly, the control target devices 121D and 121E are associated with the datagram [2] and the area 190a. The control target device 121F is associated with the datagram and the area 190b. In this way, the control system configuration information represents the correspondence relationship between the control target device (device) 121 and the datagram (control data), and in detail includes the information shown in FIG. 9D and the information shown in FIG. 9B which is related to FIG. 9D.

On the other hand, when it is determined in step S003 that the predetermined condition is not satisfied (N in step S003), the control system configuration device 124 returns to step S001. At this time, the control system configuration device 124 may return to step S002 without changing the assignment to the logical address space.

After step S004, the datagram generation information planning unit 111 transmits the planned datagram generation information to the datagram generation information storage unit 152 of the control device 120 (step S005). The control system configuration information construction unit 112 transmits the constructed control system configuration information to the control system configuration information storage unit 162 of the control device 120 (step S006).

Step S005 and step S006 may be executed in parallel as shown in FIG. 8, or may be executed in order, with either step being executed first. The datagram generation information and the control system configuration information to be transmitted to the control device 120 may be transmitted in the same communication (a communication frame or a session or connection in an upper protocol). After executing step S005 and step S006, the control system configuration device 124 ends the operation step shown in FIG. 8.

In step S002, the datagram generation information planned by the datagram generation information planning unit 111 may include not only datagrams for accessing the logical addresses, but also datagrams for initialization, such as setting logical addresses and managing state transitions (EtherCAT state machine in EtherCAT) in the control target device 121. The datagram generation information planning unit 111 may plan a communication schedule, such as the transmission timing and the communication period of each datagram, based on the information of the control target device 121 stored in the control system information storage unit 110.

When the control device 120 includes a plurality of communication units 159, the datagram generation information planning unit 111 may divide and plan the datagram generation information for each communication unit 159. At this time, when the divided datagram generation information planned in each communication unit 159 includes the expected value of the WKC 178, the expected value of the WKC 178 is determined based on the control target device 121 connected to each communication unit 159. Alternatively, only the expected value of the WKC 178 may be defined for each communication unit 159 in certain datagram generation information. When the control device 120 includes a plurality of communication units 159, the control system configuration information constructed by the control system configuration information construction unit 112 may include an identifier of the communication unit 159 of the control device 120 to which the target control target device 121 is connected.

In addition, in the control system s configuration information constructed by the control system configuration information construction unit 112, the association of the logical address with the area 190 is freely set and does not need to be included in the control system configuration information. Alternatively, when the control system configuration information includes the association with the area 190, the data storage unit 151 of the control device 120 may associate each area 190 of the logical address with the storage position of the data stored in the data storage unit 151. For example, in FIG. 9B, since the area 190a occupies an area of 2000 bytes from the logical address 0x00000000, for example, in the data storage unit 151, an area of 2000 bytes from a specific address (for example, 0x00000000) may be designated as the data area of the control target devices 121A, 121B, 121C, 121D, and 121E in the same manner as the area 190a.

### Transmission Processing Step of Control Device 120

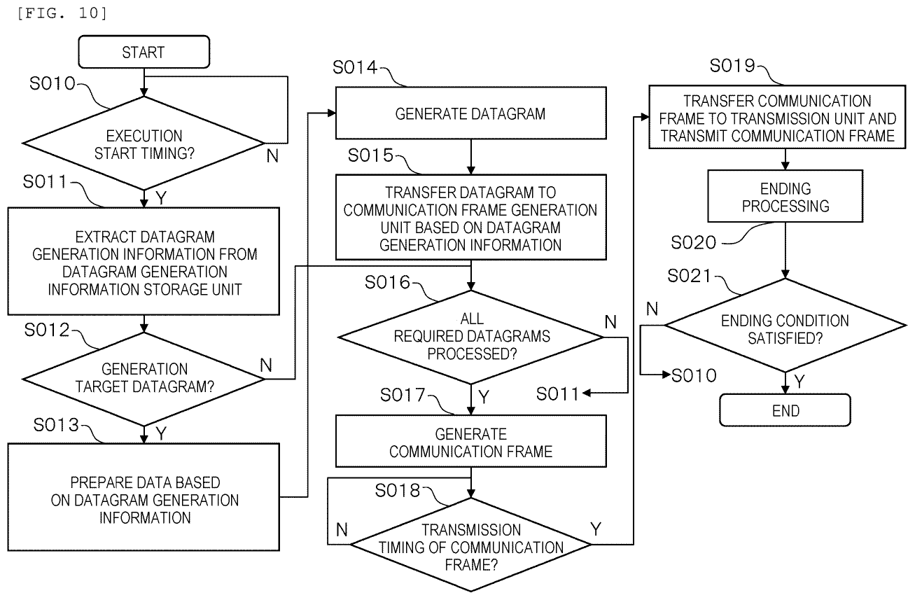

FIG. 10 is a flowchart showing an example of an execution step of transmission processing in the control device 120 shown in FIG. 3. In FIG. 10, first, the datagram generation unit 153 waits for an execution start timing (step S010). The execution start timing of the datagram generation unit 153 is determined based on, for example, the control system configuration information, the transmission timing and the communication period designated by the control system information, and the like. The control system configuration information is stored in the control system configuration information storage unit 162, and the control system information is stored in the control system information storage unit 110 in the control system configuration device 124.

Alternatively, the execution start timing of the datagram generation unit 153 may be determined according to a notification from the calculation unit 150. The notification from the calculation unit 150 to the datagram generation unit 153 is, for example, a notification indicating to start or end a data access to the data storage unit 151 by the calculation unit 150. The execution start timing may be a transmission timing defined in the datagram generation information. Alternatively, the execution start timing may be determined based on a period that is the greatest common divisor of periods defined in a plurality of pieces of datagram generation information.

A first start time may be set by a system operator or the like as a predetermined time, and the time may be set based on a time of the control device 120. Alternatively, the first start time may be set as a time based on a time system synchronized with a time synchronization protocol such as a distributed clock protocol.

Next, the datagram generation unit 153 extracts datagram generation information from the datagram generation information storage unit 152 (step S011). Then, the datagram generation unit 153 determines whether the datagram generation information extracted in step S011 is a datagram generation target (step S012). In order to determine whether the datagram generation information extracted in step S011 is a datagram generation target, for example, valid or invalid information may be included in the datagram generation information. In this case, the datagram generation unit 153 may determine that the datagram generation information is a generation target when the valid information is included.

Alternatively, in the EtherCAT state machine (ESM), a state in which the datagram generated based on the datagram generation information is to be transmitted may be included in the datagram generation information. In this case, the datagram generation unit 153 may determine that the datagram generation information is the generation target when the state matches the state designated by the control device 120. Alternatively, the datagram generation information may include a transmission period. In this case, the datagram generation unit 153 may determine that the datagram generation information is the generation target when the elapsed time from the previous transmission time matches the transmission period or when the transmission period elapses.

In the case of such a configuration, for example, a unit for storing the previous transmission time may be provided, and the previous transmission time may be stored in the datagram generation information, or the datagram generation unit 153 may include a storage unit and store the previous transmission time. Alternatively, the next scheduled transmission time may be stored, and the datagram generation unit 153 may determine that the datagram generation information is the generation target when that time is reached. A transmission timing may be defined using a predetermined transmission pattern instead of a fixed transmission period. For example, datagrams may be transmitted at intervals of 200 microseconds, 300 microseconds, and 500 microseconds in a period of 1 millisecond, and the datagram generation unit 153 may determine that the datagram generation information is the generation target when an elapsed time from the previous transmission time matches the transmission pattern or when the transmission period elapses.

A determination reference for the generation target may be any one or a plurality of the above-described determination references. In the case of a plurality of conditions, the conditions may be that any one of the conditions is met (a logical OR), or that all of the conditions are met (a logical AND), or that a condition defined by any logical expression is met. As any logical expression, for example, when “the datagram generation information includes valid information, and the state matches or the transmission timing matches a predetermined condition”, it is determined that the datagram generation information is the generation target.

When it is determined in step S012 that the datagram generation information is the generation target (Y in step S012), the datagram generation unit 153 prepares data based on the datagram generation information (step S013). At this time, the datagram generation unit 153 may control data preparation processing based on a characteristic of a command included the command in the datagram generation information.

For example, when the datagram to be generated is a write command, the write command is a command (write, write direction) from the control device 120 to the control target device 121. Therefore, the datagram generation unit 153 extracts data corresponding to a command value from the data storage unit 151. At this time, the datagram generation information includes information indicating the position and the size of the target data in the data storage unit 151, and the datagram generation unit 153 refers to the information, for example. That is, the datagram generation unit 153 extracts required data from the data storage unit 151 using the position and the size of the data.

Regarding the storage position of the data, the storage position may be included in the datagram generation information, or when the datagram generation information has an order, the storage position may be calculated by accumulating the size of the datagram generation information that is positioned earlier in the order of the extracted datagram generation information. When storage areas of the data storage unit 151 are divided by a write characteristic command and a read characteristic command, for example, a storage position may be calculated by adding a size of datagram generation information of the write characteristic command only. At this time, whether special commands such as an auto increment read multiple write (ARMW) command or a configured read multiple write (FRMW) command are included in a write characteristic command may be statically predefined by a system operator or the like.

On the other hand, when the datagram to be generated is a read command, the communication is for the control device 120 to acquire information of the control target device 121 (reading or a read direction). Therefore, the datagram generation unit 153 does not extract data from the data storage unit 151, but generates a datagram whose contents are empty or zero and whose data size is a read size. This is because a data area corresponding to the read size is required for a read command in the EtherCAT. When there is a feature that a size is constant in the control system 123, size information may not be included in the datagram generation information.

In the case of the special commands such as the ARMW command or the FRMW command which reads only a designated control target device 121 and writes data to the other control target devices 121, the datagram generation unit 153 may extract data from the data storage unit 152, or in the case of a read command, the datagram generation unit 153 may generate a datagram whose content is empty or zero and whose data size is a read size. At this time, the switching may be performed based on address information included in the datagram generation information.

For example, when a command is ARMW and an auto-increment address is 0, the control target device 121 adjacent to the control device 120 is read. In such a case, since transmitted datagram information is immediately overwritten by reading processing on the adjacent control target device 121, processing of extracting data from the data storage unit 151 in the control device 120 is no longer necessary. Therefore, when the command is ARMW and the auto-increment address is 0, for example, data is not extracted from the data storage unit 151.

Subsequently, the Datagram Generation Unit 153 generates a datagram based on the datagram generation information and the prepared data (step S014). In order to generate a datagram 175 shown in FIG. 4, the datagram generation information includes at least the command 179, the address 181, and the size 182. The command 179 indicates an access content to a logical address. The index 180, the IRQ 186, and the WKC 178 may be included in the datagram generation information when values are to be designated. When it is not necessary to designate the values of the index 180, the IRQ 186, and the WKC 178, for example, the values may be set to a default value (for example, 0). The MORE 185 may be included in the datagram generation information when it is desired to explicitly indicate whether the datagram is a last datagram.

In this manner, the datagram generation unit 153 generates a datagram by combining header information extracted from the datagram generation information, the data prepared in step S013, and the WKC 178. Further, the datagram generation unit 153 transfers the generated datagram to the corresponding communication frame generation unit 154 based on the datagram generation information (step S015). Here, for example, when a plurality of communication frame generation units 154 are provided, when a content to be notified to all of the control target devices 121 is acquired or the information is acquired from all of the control target devices 121, the information is transferred to all of the communication frame generation units 154 by using a broadcast command (a BRD command, a BWR command, or a BRW command).

Alternatively, for example, a datagram is transferred to a plurality of communication frame generation units 154 even when the datagram is not transferred to all of the communication frame generation units 154. At this time, in order to designate the plurality of communication frame generation units 154 individually, the datagram generation information may include information in a bitmap format indicating the communication frame generation unit 154 of a datagram transfer destination. For example, each bit indicates the individual communication frame generation unit 154, and a value is indicated by a truth value or 0 and 1. For example, when the truth value is true or when the value is 1, the datagram is transferred to the corresponding communication frame generation unit 154.

When the datagrams are transferred to the plurality of communication frame generation units 154, the datagram generation unit 153 may transmit the datagrams simultaneously or in order. From the viewpoint of an operation of the control system 123, in order to shorten an overall processing delay, it is desirable that the datagram generation unit 153 simultaneously transmits the datagram.

After the datagram is transferred to the communication frame generation unit 154 in step S015, or when it is determined in step S012 that the datagram generation information is not the generation target (N in step S012), the datagram generation unit 153 determines whether all pieces of required datagram generation information are processed (step S016). At this time, the datagram generation unit 153 may determine whether all pieces of the datagram generation information in the datagram generation information storage unit 152 are processed, or may determine that all pieces of the required datagram generation information are processed when a total data size of individual datagram generation information exceeds a predetermined value. The predetermined value for comparing the total data size is, for example, a maximum size of a communication frame. The data size of individual datagram generation information may be calculated including a size of header or tail information on a communication protocol.

Alternatively, by including the MORE 185 in the datagram generation information, the datagram generation unit 153 may determine that the datagram is the last datagram when the MORE 185 is 0 (that is, there is no subsequent datagram) and determine that all pieces of the required datagram generation information are processed. Alternatively, the datagram generation unit 153 may perform the determination based on another information on the header included in the datagram generation information. For example, when the command 179 of the datagram generation information is a predetermined command, the datagram generation information may be determined as the last datagram generation information, or when the index 180, the address 181, and the IRQ 186 are included in the datagram generation information and have predetermined values, the datagram generation information may be determined as the last datagram generation information.

Further, at this time, the datagram generation unit 153 may perform the determination based on a combination of a plurality of parameters. For example, when the command 179 and the address 181 have predetermined values at the same time, the datagram generation information may be determined as the last datagram generation information. The determination is not limited to being performed based on a parameter, and when a value of data extracted from the data storage unit 152 is a predetermined value, the datagram generation information may be determined as the last datagram generation information. For example, whether the datagram generation information is the last datagram generation information may be determined based on a combination of a parameter constituting the header 176 and a value of data extracted from the data storage unit 151.

When it is determined in step S016 that all pieces of the required datagram generation information are processed (Y in step S016), the processing proceeds to step S017. On the other hand, when it is determined in step S016 that not all pieces of the required datagram generation information are processed (N in step S016), the processing returns to step S011.

In step S017, the communication frame generation unit 154 combines the datagrams transferred from the datagram generation unit 153, appends the header and tail information according to a communication protocol of the control network 122, and generates a communication frame. In the case of EtherCAT, the Ethernet header 171 and the FCS 173 are combined with a datagram group, as shown in FIG. 4. An order of connecting the datagrams is, for example, an order in which the datagrams are transferred from the datagram generation unit 153.

In addition, the communication frame generation unit 154 may rearrange the datagrams based on configuration contents. For example, the datagrams may be rearranged in ascending order or descending order according to the sizes of the datagrams. Alternatively, a datagram that stores a predetermined command may be arranged at the head of the communication frame. For example, a read command (an LRD command) for a logical address is arranged and aggregated at the head of the communication frame.

The rearrangement may be reflected in the order of registering the datagram generation information transmitted from the datagram generation information planning unit 111 in the datagram generation information storage unit 152 in step S005 in FIG. 8, or may be reflected in the order of storing the datagram generation information in the datagram generation information storage unit 152 after registration. Alternatively, the rearrangement may be reflected in an order in which the datagram generation unit 153 accesses the datagram generation information stored in the datagram generation information storage unit 152 in step S011.

When a communication frame is generated, the communication frame generation unit 154 may set the MORE 185 of the last datagram to 0 (indicating that there is no subsequent datagram) and set the MORE 185 of the other datagrams to 1 (indicating that there is a subsequent datagram). Alternatively, in step S014, the datagram generation unit 153 may determine whether the datagram being generated is the last datagram, and when it is determined that the datagram being generated is the last datagram, set the MORE 185 to 0, and when it is determined that the datagram being generated is not the last datagram, set the MORE 185 to 1. A determination criteria used by the datagram generation unit 153 is the same as that in step S016. Alternatively, a value of the MORE 185 may be included in datagram generation information and reflected when a datagram is generated in step S014.

Next, the communication frame generation unit 154 determines whether it is a transmission timing of the generated communication frame (step S018). At this time, the communication frame generation unit 154 may not particularly determine the transmission timing, but may determine that it is the transmission timing immediately after r the end of step S017. Alternatively, if the transmission timing and the communication period are designated based on the control system configuration information stored in the control system configuration information storage unit 162 or the control System information stored in the control system information storage unit 110, the communication frame generation unit 154 may determine the transmission timing based on these information. Alternatively, the communication frame generation unit 154 may determine the transmission timing based on the transmission period defined by the datagram generation information.

When it is determined in step S018 that it is transmission timing of the communication frame, the communication frame generation unit 154 transfers the communication frame to the transmission unit 155 and transmits the communication frame via the transmission unit 155 (step S019). Next, the control device 120 executes the predetermined ending processing (step S020). As an example of the ending processing, for example, the calculation unit 150 is notified that the transmission ends.

Alternatively, in the ending processing, for example, when an abnormality occurs in steps in step S011 to step S019, the calculation unit 150 is notified of the abnormality occurrence. For example, when a total data access size exceeds a predetermined value, the calculation unit 150 is notified of such an abnormality. Alternatively, when a communication abnormality during accessing an area of the data storage unit 151, an access abnormality in the memory 104 and the nonvolatile storage media 105 that implement the data storage unit 151, a soft error (a temporary failure of a semiconductor) in the communication control IC 102, the memory 104, and the nonvolatile storage media 105 that constitute a calculation unit or a storage unit of a functional unit, or the like occurs, the calculation unit 150 may be notified of such an abnormality. In order to detect such an abnormality, for example, a device or a functional unit having an error correction code (ECC) function is used, or data is stored in the data storage unit 152, the memory 104, and the nonvolatile storage media 105 together with the error correction code such as a parity check.

By these abnormality notification, a system operator or the like can notice the abnormality and take necessary measures. As a result, execution and operation of the control system 123 can be stabilized, normalized, and recovered. For example, when the data access size exceeds a predetermined value, the datagram generation information planning unit 111 in the control system configuration device 124 may erroneously plans the datagram generation information. By investigating such a cause, when there is an erroneous setting or malfunction in the datagram generation information planning unit 111, the control system configuration information construction unit 112, or the logical address assignment planning unit 113, or in any one or a plurality of the functional units within the control device 120, the corresponding functional units can be made highly reliable by improving the setting or malfunction.

Alternatively, when the system operator or the like uses these functional units, when the system operator makes an erroneous Setting, for example, the setting is reconsidered and a function for preventing an erroneous setting is added to the functional unit of the control system configuration device 124. Specifically, for example, a user interface when operating these functional units is improved, and a check function for an assumed condition such as a size upper limit value is added.

For example, a notification associated with the ending processing in step S020 is implemented as an interrupt from the communication control IC 102 to the CPU 101. Alternatively, in the ending processing, the communication frame generation unit 154 or the transmission unit 155 may record a transmission time of a communication frame. By recording the transmission time, it is possible to measure a communication time when the same datagram is received via the control network 122, and it is possible to evaluate and visualize communication performance, and perform the abnormality determination by comparing with a timeout value. The transmission time may be stored for each datagram at the time of transferring the datagram in step S015 instead of for each communication frame.

When extracting the datagram generation information in step S011, a mode based on the ESM may be provided, and in step S012, it may be determined whether the datagram is a datagram which is the generation target in accordance with the mode. At this time, in addition to the information of the currently set mode, for example, the mode to be transmitted may be defined in the datagram generation information. The completion of the change in the state based on the ESM is, for example, confirmed in step S020. A datagram that requests the change in the state based on the ESM is exemplified by being defined as the datagram generation information.

After executing step S020, the control device 120 determines an ending condition (step S021). Examples of the ending condition include reaching a predetermined time, elapse of a predetermined time, and executing control a predetermined number of control executions. Alternatively, examples of the ending condition include reaching predetermined control performance. In addition, a system operator or the like may explicitly instruct to end processing.

When it is determined in step S021 that the ending condition is satisfied (Y in step S021), the control device 120 ends the steps shown in FIG. 10. When it is determined in step S021 that the ending condition is not satisfied (N in step S021), the processing returns to step S010. Processing from step S017 to step S020 are respectively executed by the plurality of PHYS 103, the communication frame generation unit 154, and the transmission unit 155, and thus these steps may be executed in parallel.

### Reception Processing Step of Control Device 120

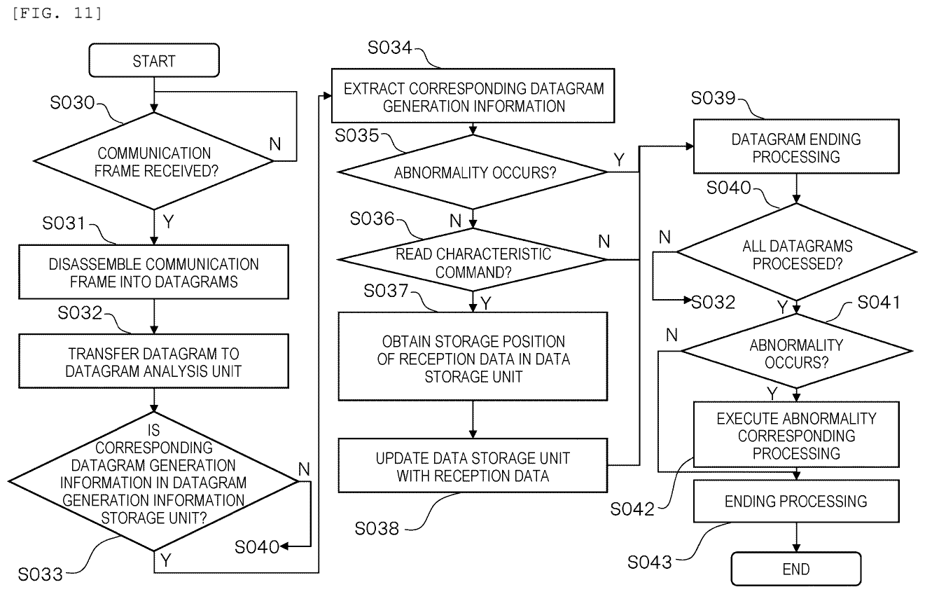

FIG. 11 is a flowchart showing an example of an execution step of reception processing in the control device 120 shown in FIG. 3. First, the reception unit 158 waits for reception of a communication frame (step S030). When the reception unit 158 receives a communication frame, the reception unit 158 transfers the communication frame to the communication frame disassembling unit 157, and the communication frame disassembling unit 157 disassembles the received communication frame into datagrams (step S031). When the received communication frame is not an EtherCAT frame, the reception unit 158 may discard the communication frame and end the processing, or may notify the calculation unit 150 or the like that a non-EtherCAT frame is received and of the received communication frame.

After the communication frame disassembling unit 157 disassembles the communication frame into the datagrams, the communication frame disassembling unit 157 transfers the individual datagram to the datagram analysis unit 156 (step S032). When the datagram analysis unit 156 receives the datagram, the datagram analysis unit 156 searches the datagram generation information storage unit 152 to determine whether there is datagram generation information corresponding to the datagram (step S033).

The search for and the presence or absence of the datagram generation information is performed based on the contents of the received datagram. That is, for example, when header information and/or a data length in the reception datagram match header information included in the datagram generation information, the datagram analysis unit 156 determines that there is datagram generation information. When determining the header information, it is possible to determine whether only a part of the parameters such as the command 179, the address 181, and the size 182 are the same, without determining whether all the parameters are the same.

When the datagram generation information storage unit 152 stores the corresponding datagram generation information (Y in step S033), the datagram analysis unit 156 extracts the datagram generation information (step S034). Further, the datagram analysis unit 156 shares the extracted datagram generation information and the reception datagram with the abnormality determination unit 163, and the abnormality determination unit 163 determines the abnormality of the reception datagram (step S035). The operation of the abnormality determination unit 163 will be described later.

In step S035, when there is no abnormality in the reception datagram (N in step S035), the datagram analysis unit 156 determines whether the received datagram is a read characteristic command (step S036). When the reception datagram is a read characteristic command, reception data needs to be reflected in the data storage unit 151. Therefore, when the reception datagram is a read characteristic command (Y in step S036), the datagram analysis unit 156 determines a storage position of the reception data in the data storage unit 151 based on the searched datagram generation information (step S037).

Regarding the storage position of the reception data, the storage position may be included in the datagram generation information, or when the datagram generation information has an order, the storage position may be calculated by accumulating the size included in the datagram generation information that is positioned earlier in the order of the extracted datagram generation information. When storage areas of the data storage unit 151 are divided by a write characteristic command and a read characteristic command, for example, the storage position may be calculated by adding a size included in the datagram generation information of the read characteristic command only. Whether a special command such as an ARMW command or an FRMW command is categorized in the read characteristic command may be determined by a system operator or the like, or may be statically defined in advance.

After the storage position of the data is determined, the datagram analysis unit 156 extracts the reception data from the datagram and updates a corresponding area of the data storage unit 151 (step S038). After the completion of step S038, when there is an abnormality in the reception datagram in step S035 (Y in step S035), or when the reception datagram is not a read characteristic command (N in step S036), the datagram analysis unit 156 executes ending processing in which the datagram processing is performed (step S039). The ending processing of the datagram processing is, for example, counting up the number of times of receiving a datagram and a reception data size.

After the execution of step S039 or when it is determined in step S033 that there is no datagram generation information corresponding to the reception datagram (N in step S033), the control device 120 determines whether all datagrams are processed (step S040). For example, it is determined whether all datagrams included in the received communication frame are processed. Alternatively, it may be determined that all datagrams are processed when a datagram matching a predetermined condition such as a value of a header parameter and a value of the WKC is received.

When it is determined in step S040 that not all datagrams are processed (N in step S040), the control device 120 returns to step S032. On the other hand, in step S040, when it is determined that all datagrams are processed (Y in step S040), the datagram analysis unit 156 and the communication frame disassembling unit 157 share the received datagram group, the received communication frame, and the extracted datagram generation information with the abnormality determination unit 163, and the abnormality determination unit 163 determines an abnormality of the received communication frame (step S041).

When the abnormality determination unit 163 determines that there is an abnormality in the communication frame in step S041 (Y in step S041), the control device 120 executes the corresponding processing (step S042). The corresponding processing to the abnormality will be described later. After the execution of step S042, when it is determined in step S041 that there is no abnormality in the communication frame (N in step S041), the control device 120 executes the ending processing in which the communication frame is set (step S043), and ends the steps shown in FIG. 11.

The ending processing of the communication frame is, for example, counting up the number of times of receiving a communication frame and/or a reception data size. Alternatively, in the ending processing of the communication frame, for example, the calculation unit 150 is notified that the reception processing ends. At this time, when a plurality of communication units 159 are provided, each of the communication units 159 may be notified of completion for each reception processing for a received communication frame.

Alternatively, when a predetermined time elapses, when a predetermined number of communication frames is processed or when a predetermined reception data size (a reception size of a communication frame or a total reception size for a predetermined area shown in FIG. 4) is processed, and when a predetermined number of datagrams of the control target device 121 are processed, the calculation unit 151 may be notified that the reception processing ends. These statistical values may be determined for each communication unit 159, or may be determined by a total value of all communication units 159 or a plurality of communication units 159. When the calculation unit 150 is notified that the reception processing ends, for example, the datagram analysis unit 156 includes a unit that presents the main reason of the notification.

In the ending processing of a communication frame, for example, the data storage unit 151 or the calculation unit 150 is notified that updating of a required area of the data storage unit 151 ends. For example, a notification associated with the ending processing is implemented as an interrupt from the communication control IC 102 to the CPU 101.

Alternatively, in the ending processing, the communication frame disassembling unit 157 or the reception unit 158 may store a reception time of a communication frame. By storing the reception time, it is possible to measure a communication time when the communication frame is received, and it is possible to evaluate and visualize communication performance, and perform the abnormality determination by comparing with a timeout value. The reception time may be stored immediately after the communication frame is received in step S030 (Y in step S030). When a plurality of communication units 159 are provided, for example, the reception time may be measured for each communication unit 159. In this manner, it is possible to measure communication time for each communication unit 159, and it is possible to confirm and verify whether a connection configuration of the control target device 121 for each communication unit 159 is appropriate.

### Abnormality Determination and Corresponding Step

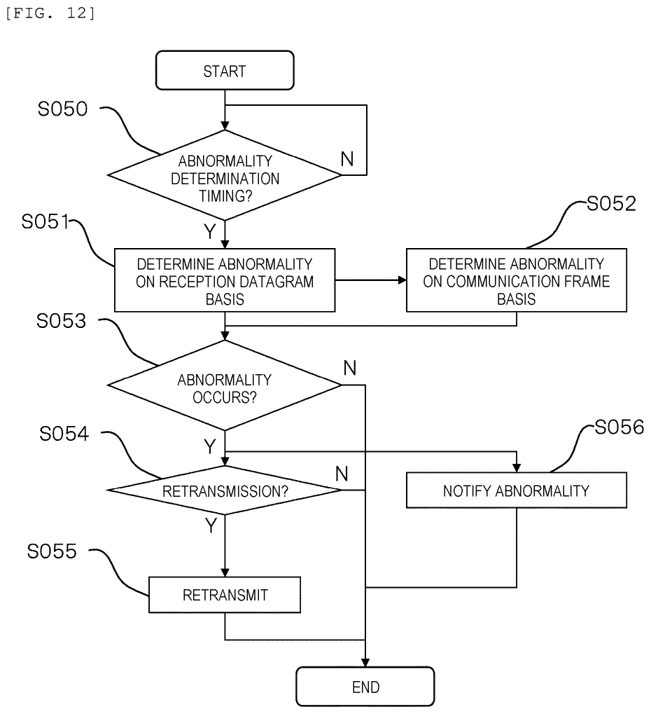

FIG. 12 is a flowchart showing an example of abnormality determination processing performed by the abnormality determination unit 163 shown in FIG. 3 and an execution step of the abnormality corresponding processing performed by the retransmission unit 164. Steps shown in FIG. 12 correspond to steps S035, S041, S042 in FIG. 11. In FIG. 12, first, the abnormality determination unit 163 waits for an abnormality determination timing (step S050). The abnormality determination timing may be a timing at which the datagram analysis unit 156 shares the reception datagram or the datagram generation information with the abnormality determination unit 163, or may be a timing at which the communication frame disassembling unit 157 shares the received communication frame with the abnormality determination unit 163.

Alternatively, the abnormality determination timing may be a timing at which a predetermined cycle elapses from any one of the following timings (A) to (C). The abnormality determination timing is a timing corresponding to a timeout value for detecting a loss of a communication frame on the control network 122.
(A) A timing at which the datagram generation unit 153 transfers a generated datagram (for example, the first datagram in the communication frame) to the communication frame generation unit 154.
(B) A timing at which the communication frame generation unit 154 transfers a generated communication frame to the transmission unit 155.
(C) A timing at which the transmission unit 155 starts transmission of a communication frame.

When the timing of the abnormality determination is reached in step S050 (Y in step S050), the abnormality determination unit 163 executes the abnormality determination on a reception datagram basis (step S051) and executes the abnormality determination on a received communication frame basis (step S052). Step S051 and step S052 may be executed in parallel as shown in FIG. 12, or may be executed in order by executing any one step first. Alternatively, when there is no corresponding information, the abnormality determination unit 163 may execute only one of the steps.

For example, when the communication frame includes a plurality of datagrams and only the head datagram is transferred from the datagram analysis unit 156 to the abnormality determination unit 163, the abnormality determination unit 163 cannot determine the abnormality in the communication frame, and therefore only the step S051 is executed. On the other hand, for example, when the timing of the abnormality determination according to the timeout is reached, the abnormality determination unit 163 performs only the step S052 because the abnormality determination cannot be performed on the individual datagram. When determining an abnormality of cyclic redundancy check (CRC) in the FCS 173, the FCS 173 is appended to each communication frame, and the abnormality determination unit 163 executes only the step S051 in order to determine the abnormality of the communication frame.

When determining whether there is an abnormality in the datagram in step S051, an expected value of the WKC 178 at the time of receiving the datagram may be set in the datagram generation information. In this case, the abnormality determination unit 163 may compare the value of the WKC 178 contained in the received datagram with the expected value, and determine that there is an abnormality when the values are not equal. Alternatively, the abnormality determination unit 163 may determine that an abnormality occurs when a format of the received datagram does not match a format defined by the communication protocol.

When determining whether there is an abnormality in the communication frame in step S052, a timeout value may be determined for communication of the communication frame, for example. In this case, the abnormality determination unit 163 may determine that an abnormality occurs when the length of time from the timing of transferring the datagram in step S015 in FIG. 10 or transferring or sending the communication frame in step S019 to the timing of receiving the communication frame in step S030 in FIG. 11 or receiving the datagram in step S032 exceeds the timeout value.

Alternatively, the abnormality determination unit 163 may determine that an abnormality occurs when an abnormality is detected in a cyclic redundancy check (CRC) using the FCS 173 in the received communication frame. The abnormality determination by the CRC may be performed immediately after the communication frame is received in step S030 (Y in step S030) in FIG. 11. That is, in step S050 in FIG. 12, the timing at which the communication frame is received is set as the timing of the abnormality determination. In addition, when the format of the received communication frame does not match the format defined by the communication protocol, the abnormality determination unit 163 may determine that the format is abnormal.

Alternatively, the abnormality determination unit 163 may detect abnormalities such as communication abnormalities when accessing an area of the data storage unit 151, access abnormalities in the memory 104 and the nonvolatile storage media 105 that implement the data storage unit 151, and soft errors in the communication control IC 102, the memory 104, and the nonvolatile storage media 105 that constitute a calculation unit and a storage unit of the functional unit. Further, the abnormality determination unit 163 may detect the abnormality occurring in the step S038 in FIG. 11. In order to detect such an abnormality, for example, a device or a functional unit having an error correction code (ECC) function is used, or data is stored in the data storage unit 151, the memory 104, and the nonvolatile storage media 105 together with the error correction code such as a parity check.

After the abnormality determination in steps S051 and S052, the abnormality determination unit 163 confirms whether an abnormality occurs (step S053). When an abnormality occurs (Y in step S053), the abnormality determination unit 163 determines whether retransmission is necessary (step S054) and issues an abnormality notification (step S056). Step S054 and step S056 may be executed in parallel as shown in FIG. 12, or may be executed in order by executing any one step first. Alternatively, only one of steps may be executed.

Regarding the determination of whether the retransmission is necessary in step S054, a system operator or the like may set up in advance to execute the retransmission when an abnormality occurs, and the abnormality determination unit 163 may determine to retransmit based on that setting. Alternatively, by setting an upper limit on the number of retransmissions within predetermined cycle, the abnormality determination unit 163 may determine not to retransmit when the number of retransmissions reaches the upper limit, even when it is determined in step S053 that an abnormality occurs.

Alternatively, in the datagram generation information stored by the datagram generation information storage unit 152, whether each datagram is to be retransmitted may be set, and thus the abnormality determination unit 163 may determine to retransmit a datagram when the datagram in which an abnormality has occurred is determined corresponds to a datagram to be retransmitted. Similarly, when the datagram in which an abnormality occurs does not correspond to a datagram to be retransmitted, the abnormality determination unit 163 may determine not to retransmit the datagram.

Alternatively, when no abnormality occurs until the reception processing, and an abnormality occurs during access to the data storage unit 151, the memory 104, or the nonvolatile storage media 105, the abnormality determination unit 163 may determine not to retransmit. In such a case, the abnormality determination unit 163 may, for example, cause the datagram analysis unit 156 or the like to access the data storage unit 151, the memory 104, and the nonvolatile storage media 105 again. When a re-access fails, or when the re-access fails a predetermined number of times, the abnormality determination unit 163 notifies the calculation unit 150 or an external device, for example.

In step S054, when it is determined that the retransmission is to be performed (Y in step S054), the abnormality determination unit 163 transfers, to the retransmission unit 164, one of the datagram to be retransmitted, the communication frame, and the datagram generation information, or a plurality of pieces of information, and the retransmission unit 164 retransmits the information using the information (step S055). In the case of the retransmission, the retransmission may be performed on a communication frame basis, or the retransmission may be performed on a datagram basis that is determined to be abnormal due to a WKC mismatch or the like.

In order to perform the retransmission, the retransmission unit 164 may construct a datagram or a communication frame based on the information transferred from the abnormality determination unit 163 and transfer the datagram and the communication frame to the transmission unit 155. Alternatively, a datagram transferred from the datagram generation unit 153 to the communication frame generation unit 154 or a communication frame transferred from the communication frame generation unit 154 to the transmission unit 155 may be transferred to the retransmission unit 164. In this case, based on the information transferred from the abnormality determination unit 163 to the retransmission unit 164, the retransmission unit 164 may identify the datagram or the communication frame that needs to be retransmitted and transfer the data to the transmission unit 155.

At this time, the retransmission unit 164 may change parameters on the datagram or the communication frame to be transferred to the transmission unit 155 so that it is possible to determine that this is retransmission. Examples of such parameters include any one of a transmission destination MAC address, a transmission source MAC address, the index 180, and the data area 177 on the Ethernet header 171 or a plurality thereof. A change target may be a part of the selected parameter (for example, a part of the transmission source MAC address or a predetermined bit of the index 180). In accordance with the change in the configuration of the communication frame, the retransmission unit 164 may change parameters such as the MORE 185.

In step S056, when it is determined that an abnormality occurs, the abnormality determination unit 163 notifies the calculation unit 150 of information related to the abnormality. Examples of the information related to the abnormality include any one of information related to the relevant datagram or communication frame, information related to the datagram generation information, a reason of abnormality, an occurrence timing of an abnormality, and an occurrence time, or a plurality thereof. When the calculation unit 150 is notified of the abnormality occurrence, when it is possible to identify the communication unit 159 in which the abnormality occurs, the communication frame, the datagram and the like, the abnormality determination unit 163 may notify one piece or a plurality pieces of the identification information, for example.

A unit by which the abnormality determination unit 163 notifies the calculation unit 150 is, for example, an interrupt signal or register information accessible by the CPU 101. Alternatively, the abnormality determination unit 163 may report and present an abnormality through an external presentation unit such as a display, an LED, or a speaker that may be included in the control device 120. Alternatively, in step S056, the abnormality determination unit 163 may, for example, count number of abnormality occurrences.

### Change Step of System Configuration

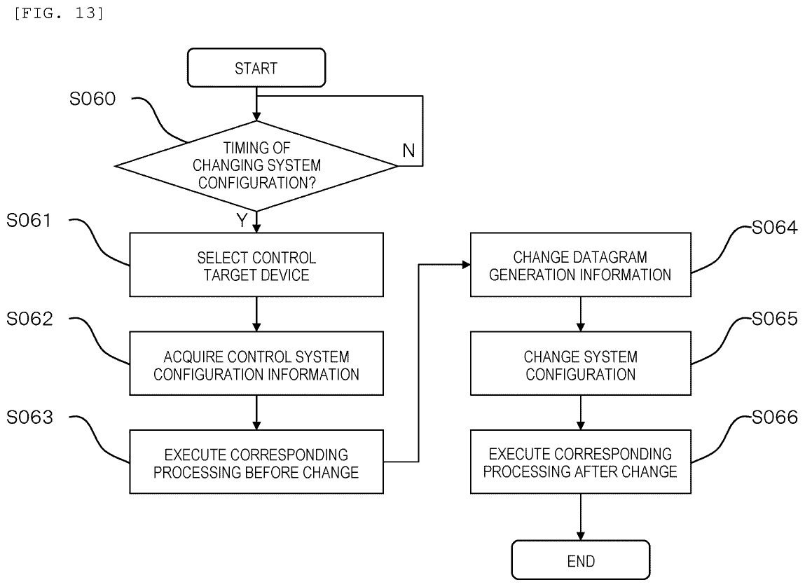

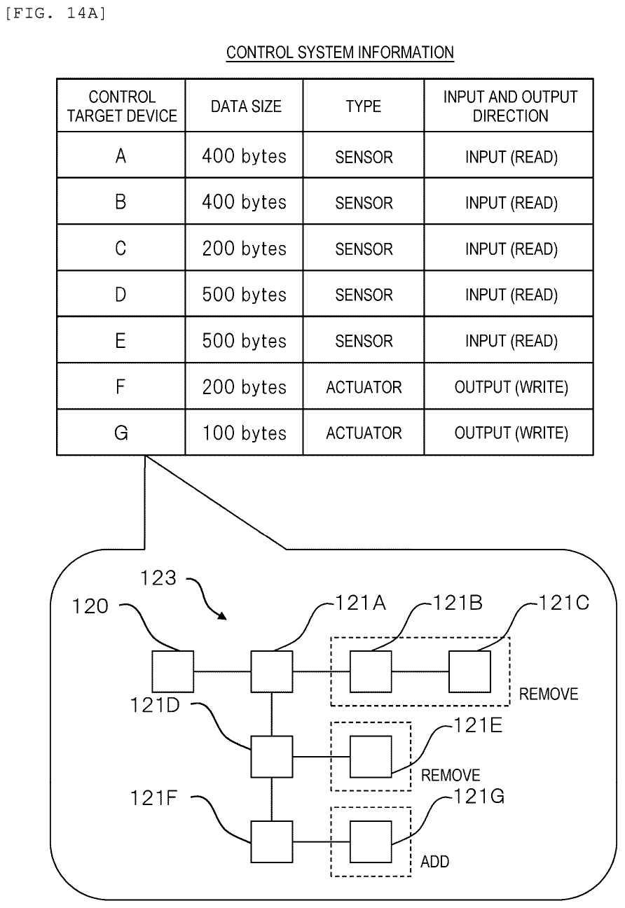

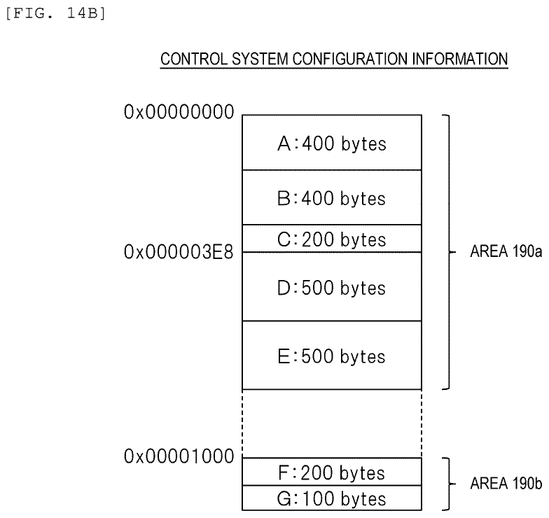

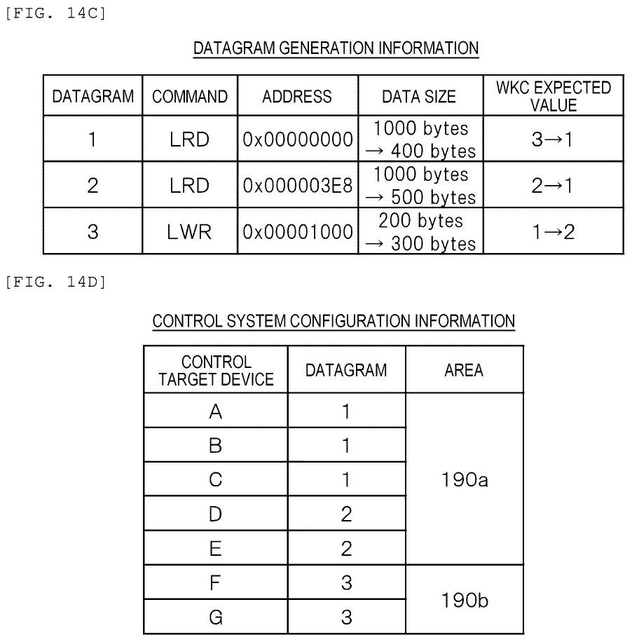

FIG. 13 is a flowchart showing an example of an execution step when the system configuration is changed by the control target device selection unit 160, the datagram generation information change unit 161, and the control system configuration information storage unit 162 in FIG. 3. FIGS. 14A, 14B, 14C and 14D are diagrams showing a specific example of the execution step shown in FIG. 13. FIG. 14 is based on the example shown in FIG. 9. The system configuration change represents addition or removal of the control target device (device) 121, and represents an information change of the device.

In FIG. 13, first, the control device 120 waits for a timing of changing the system configuration (step S060). An example of such a timing is a timing at which the operator or the like explicitly changes the system configuration. In addition, examples include a timing after the control device 120 executes a predetermined number of communications, or a timing after a predetermined communication size is executed (which may be a communication size for the entire control system 123, or a communication size for a predetermined control target device 121). In addition, examples of the timing include a timing after a predetermined operating time elapses, a timing at which predetermined performance is reached as the control system 123, or a timing at which a predetermined processing operation is completed.

Alternatively, the timing may be a timing based on a predetermined cycle. At this time, a degree of the period is not particularly limited, and may be, for example, a period in a relatively short period of 10 milliseconds every 5 seconds, or a relatively long period within a period such as one hour from 1:00 pm to 2:00 pm on Monday in a week. Here, the period required for the change is also defined (10 milliseconds elapsed, 1 hour), but the original configuration does not have to be restored until a predetermined condition is satisfied, or the system configuration may be maintained as is.

Alternatively, a change in the system configuration may be started in the control device 120 or the predetermined control target device 121 upon detection of a predetermined event in the control system 123. For example, under a premise that the control target device 121 includes a predetermined sensor and the control device 120 collects sensor values, the control device 120 determines a timing at which the system configuration is changed when the sensor value satisfies a predetermined criterion.

When the system is changed by time designation, the target control target device 121 may be automatically connected to or disconnected from the control system 123. In the case of connection, a power supply is automatically turned on in a state in which the control target device 121 is physically connected to the control system 123, for example. In the case of disconnection, the power supply to the control target device 121 is automatically stopped in a state in which the control target device 121 is physically connected to the control target device 121, for example. The time at which automatic processing is executed is, for example, the time synchronized by the DC protocol.

When the timing of changing the system configuration in step S060 is reached (Y in step S060), the control target device selection unit 160 selects the control target device 121 to be changed (step S061). In this case, there may be any one or a plurality of the following cases: a case in which the control target device 121 is added to the control system 123, a case in which the control target device 121 is removed from the control system 123, or a case in which the control target device 121 is replaced.

As a specific example, it is assumed that the control target devices 121B, 121C, and 121E are removed and a control target device 121G is newly added in the control system 123 shown in FIG. 14A. As an example of operation in this case, the operator selects the target control target device 121 via an HMI provided in the control system management device 125, and the control system management device 125 transmits the selected information to the control device 120.

When the system configuration is automatically changed when a predetermined condition is satisfied in step S060, the control target device 121 to be changed based on the condition may be defined in advance. That is, the correspondence between the change factor of the system configuration and the control target device 121 to be changed may be defined in advance. In this way, the control device 120 can automatically select the target control target device 121 based on the change factor. For example, when the system configuration is changed when a predetermined event in the control system 123 is sensed, the control target device 121 may be defined in advance to determine the control target device 121 based on a type of the sensor or a sensor value.

Next, the datagram generation information change unit 161 acquires the control system configuration information stored in the control system configuration information storage unit 162 (step S062). For example, the control system configuration information shown in FIG. 14D is shown. In FIG. 14D, the control target device 121G is added to the control system configuration information shown in FIG. 9D. When the control system configuration information stored in the control system configuration information storage unit 162 is changed, the control system configuration information stored in the control system configuration information storage unit 162 may be changed by executing the steps shown in FIG. 8 at any timing.

Then, the datagram generation information change unit 161 executes the corresponding processing before the datagram generation information is changed (step S063). Examples of the corresponding processing include stopping communication and stopping a control calculation of the control system 123. Alternatively, the abnormality determination based on comparison with the expected value of the WKC 178 may be invalidated. Accordingly, the abnormality determination unit 163 does not compare the value of the WKC 178 at the time of reception with the expected value, and therefore the retransmission shown in steps S054 and S055 shown in FIG. 12 may not be performed.

Alternatively, when the control target device 121 is removed, the control device 120 may stop the communication with the control target device 121 selected in step S061. Alternatively, examples of the corresponding processing include changing the ESM, changing the communication period, and stopping time synchronization using the DC protocol. The processing may not be executed as the corresponding processing in step S063. In step S060, when the system configuration is automatically changed, the corresponding processing according to step S063 may be executed in a predetermined period in a predetermined cycle.

Next, the datagram generation information change unit 161 changes the datagram generation information (the communication control information) stored in the datagram generation information storage unit 152 based on the acquired control system configuration information, that is, the correspondence relationship between the control target device 121 and the datagram (step S064). Examples of information to be changed include a part or a plurality of the parameters of the header 176 and expected values for the value of the received WKC 178.

As a specific example when the expected value of the WKC 178 is changed, first, the datagram generation information change unit 161 recognizes that the control target devices 121B and 121C to be removed are included in the datagram [1] based on the control system configuration information shown in FIG. 14D, that is, the holding information of the control system configuration information storage unit 162. Therefore, in order to remove the two control target devices 121 from the control system 123, the datagram generation information change unit 161 changes the expected value of the WKC 178 for the datagram [1] from 3 to 1, which is obtained by subtracting 2, as shown in FIG. 14C.

Similarly, the datagram generation information change unit 161 recognizes that the control target device 121E to be removed is included in the datagram [2] based on the control system configuration information shown in FIG. 14D. Therefore, in order to remove the control target device 121E from the control system 123, the datagram generation information change unit 161 changes the expected value of the WKC 178 for the datagram [2] from 2 to 1, which is obtained by subtracting 1, as shown in FIG. 14C.

Further, based on the control system configuration information shown in FIG. 14D, the datagram generation information change unit 161 recognizes that the additional control target device 121G is newly included in the datagram [3]. Therefore, in order to add the control target device 121G to the control system 123, the datagram generation information change unit 161 changes the expected value of the WKC 178 for the datagram [3] to 2, which is obtained by adding 1 to 1, as shown in FIG. 14C.

In addition, the datagram generation information change unit 161 may change the size (the size 182 as a parameter) of the data area 177. As a specific example, in FIG. 14A, the control target devices 121B and 121C are removed from the control system 123. Therefore, as shown in FIG. 14C, the datagram generation information change unit 161 changes the size of the data area 177 for the datagram [1], that is, the size 182 in FIG. 4, to 400 bytes, obtained by subtracting 600 bytes, which is the total size of the control target devices 121B and 121C, from 1000 bytes.

At this time, the datagram generation information change unit 161 can acquire, from the control system configuration information shown in FIG. 14D, that the communication addressed to the control target devices 121B and 121C is included in the datagram [1]. Further, the datagram generation information change unit 161 can acquire, from the control system configuration information shown in FIG. 14A, that the total size of the data areas 177 of the control target devices 121B and 121C is 600 bytes.

Similarly, the datagram generation information change unit 161 recognizes that the control target device 121E to be removed is included in the datagram [2] based on the control system configuration information shown in FIG. 14D. Therefore, in order to remove the control target device 121E from the control system 123, the datagram generation information change unit 161 changes the size of the data area 177 corresponding to the datagram [2] to 500 bytes obtained by subtracting 500 bytes, which is the size of the control target device 121E, from 1000 bytes, as shown in FIG. 14C.

Further, based on the control system configuration information shown in FIG. 14D, the datagram generation information change unit 161 recognizes that the additional control target device 121G is newly included in the datagram [3]. Therefore, in order to add the control target device 121G to the control system 123, the datagram generation information change unit 161 changes the size of the data area 177 for the datagram [3] from 200 bytes to 300 bytes, which is an addition of 100 bytes, which is the size of the control target device 121G, as shown in FIG. 14C.

When the size 182 of the data area 177 is changed, the assignment information of the logical address space by the logical address assignment planning unit 113 when the control system configuration information construction unit 112 constructs the control system configuration information is required in step S004 shown in FIG. 8. On the other hand, the size 182 of the data area 177 may not be changed. However, use efficiency of a communication bandwidth of the control network 122 can be improved by changing the size 182 of the data area 177.

In addition, when a constituent unit of the datagram is subdivided in the control target device 121 instead of the unit of the control target device 121, it is shown that a plurality of pieces of datagram configuration information related to the control target device 121 selected in step S061 in FIG. 13 is changed. For example, in FIG. 14D, when the area of the control target device 121D is divided and included in each of the datagram [1] and the datagram [2], the datagram configuration information (for example, the expected value of the WKC 178) of the datagram [1] and the datagram [2] is changed in FIG. 14C.

After the datagram generation information is changed in this manner (step S064), the system configuration of the control system 123 is automatically changed (step S065). For example, when the control target device 121 is removed, the power supply of the control target device 121 selected in step S061 is automatically or manually stopped. As an example, when the control system 123 is a semiconductor manufacturing device, the power supply to the control target device 121 is stopped when performing maintenance such as cleaning a reaction product deposited in a chamber. In such a case, although the control target device 121 is physically present in the control system 123, the control target device 121 is in an invalid state in the control system 123 because the power supply is stopped. The target system configuration change also includes such a case.

As a specific example, in the example shown in FIG. 14A, the control device 120, the control system management device 125 (not shown), or the like may stop the power supply by transmitting a power supply stop command to the control target devices 121B, 121C, and 121E via the control network 122, and may logically remove the power supply from the control system 123. An operator, a worker, or the like may manually operate the control target device 121 to stop the power supply. At this time, the control target devices 121B, 121C, and 121E may be physically carried and removed from the control system 123.

Alternatively, the target control target device 121 may be set not to change the parameter (for example, the WKC 178) used for the abnormality determination in the abnormality determination unit 163. Examples of the setting include sending a command to the control target device 121 via the control network 122, connecting a maintenance PC to the control target device 121 with a USB cable or the like, or setting the device using an operation interface (for example, a DIP switch) provided on the control target device 121.

Also in the control target device 121G, an operator or a worker may carry the control target device 121G in the control system 123, connect to a power supply or the control network 122, and add the control target device 121G to the control system 123. In addition, the power supply of the control target device 121G provided in the control system 123 may be manually started, or the power supply of the control target device 121G may be automatically started via the control network 122 using a Wake-on-LAN function.

Thereafter, the datagram generation information change unit 161 executes the corresponding processing after the system change (step S066). Examples of the corresponding processing include re-operating communication of the control system 123, re-operating communication to the changed control target device 121, validating the comparison with the expected value of the WKC 178, changing the ESM, re-assigning the logical address, setting the SyncManager, changing the communication period, and re-executing time synchronization by the DC protocol.

Alternatively, the corresponding processing may involve confirming the connection order of the control target devices 121. As a specific example, the control system configuration information includes information of the connection order of the control target device 121 (for example, an auto-increment address of each control target device 121). The control device 120 may sequentially change a value of the auto-increment address and sequentially access the addresses that store identification information of each of the control target devices 121 to confirm whether the connection order is as desired.

The corresponding processing in step S066 may be omitted. In addition, in step S060, when the system configuration is automatically changed, the corresponding processing according to step S066 may be executed in a predetermined period in a predetermined cycle. After executing step S066, the control device 120 ends the execution step shown in FIG. 13. In the control device 120, the transmission step shown in FIG. 10, the reception step shown in FIG. 11, the abnormality determination step shown in FIG. 12, and the corresponding step are executed based on the datagram generation information changed based on the change step of the system configuration shown in FIG. 13.

In FIG. 14, the command for the logical address is mainly described, whereas the datagrams that are the subject of changes are not limited thereto. For example, commands for the auto-increment address (APRD, APWR, APRW), commands for a station address (FPRD, FPWR, FPRW), broadcast commands (BRD, BWR, BRW), a NOP command, an ARMW command, and a FRMW command are exemplified.

For example, regarding the datagram generation information for the control target device 121 selected in step S061, it is assumed that an access to a target address is possible by using a command for accessing the auto-increment address or the station address. The expected value of the WKC 178 in this case is 0 when the control target device 121 is removed from the control system 123, and is 1 when the control target device 121 is added to the control system 123. However, in the case of the read and write command, the expected value of the WKC 178 is 1 (when the access destination register is read-only), 2 (when the access destination register is read-only), and 3 (when the access destination register supports read and write).

As another example, regarding the datagram generation information for the selected control target device 121, it is assumed that an access to the target address using a broadcast command is possible. In this case, the expected value of WKC 178 is, for example, set to a value obtained by subtracting the number of selected control target devices 121 from the total number of control target devices 121 when the control target device 121 is removed from the control system 123, and set to a value obtained by adding the number of control target devices 121 to be added when the control target device 121 is added to the control system 123. However, in the case of the read and write command, the value to be changed to one control target device 121 is one of 1 (when the access destination register is read-only), 2 (when the access destination register is read-only), and 3 (when the access destination register supports read and write).

As yet another example, it is assumed that one control target device 121 is implemented to respond with a NOP command that is to be normally ignored. The expected value of the WKC 178 in this case is, for example, a value obtained by subtracting 1 when the control target device 121 is removed from the control system 123, and a value obtained by adding 1 when the control target device 121 is added to the control system 123.

As yet another example, regarding the datagram generation information for the selected control target device 121, it is assumed that an access to the target register using the ARMW command or the FRMW command is possible. In this case, the expected value of WKC 178 is, for example, set to a value subtracted by the number of selected control target devices 121 when the control target device 121 is removed from the control system 123, and set to a value added by the number of selected control target devices 121 when the control target device 121 is added to the control system 123.

In the change of the datagram generation information in step S064, the auto-increment address may be changed if the command is a command for the auto-increment address. For example, when a control target device 121 is removed from the control system 123, control target devices 121 following the control target device 121 are moved up in the connection order. Therefore, for example, the auto-increment addresses of the control target devices 121 following the control target device 121 to be removed are added by one each.

Similarly, when a control target device 121 is added to the control system 123, control target devices 121 following the control target device 121 are moved down in the connection order. Therefore, for example, the auto-increment addresses of the control target devices 121 following the added control target device 121 are decremented by one each.

When removing a control target device 121 from the control system 123, when a datagram defined in the datagram generation information is a datagram for only the control target device 121 to be removed, the control device 120 may determine that the datagram is not the datagram which is the generation target in the step S012 shown in FIG. 10 (N of the step S012). When the control device 120 includes the plurality of communication units 159, in step S064 shown in FIG. 13, the control device 120 changes the datagram generation information of the datagram transmitted from the communication unit 159, for the communication unit 159 connected to the control target device 121 selected in step S061.

### Example of Reconnection

When the removed control target device 121 or the added control target device 121 is returned to an original state again (when the removed control target device 121 is reconnected or the added control target device 121 is removed), the steps shown in FIG. 13 are executed again, for example.

### Assignment of Control Target Device 121 to be Changed to Logical Address

When the control target device 121 to be added to or removed from the control system 123 is known in advance, in step S001 shown in FIG. 8, for example, when assigning the logical address, the logical address assignment planning unit 113 may aggregate and assign the control target device 121 to be changed to the head or the tail of the logical address. In this way, even when the control target device 121 is removed from the control system 123, the input and output of the remaining control target device 121 are assigned to a continuous space. Therefore, it is not necessary to divide the datagram and to include an invalid area on the datagram.

Similarly, even when the control target device 121 is added to the control system 123, a continuous space including the input and output of the control target device 121 to be added is assigned, and thus there is no need to divide the datagram or include the invalid area on the datagram. Therefore, as described below, the logical address space can be utilized efficiently, and an effect of improving use efficiency of a communication bandwidth can be obtained.

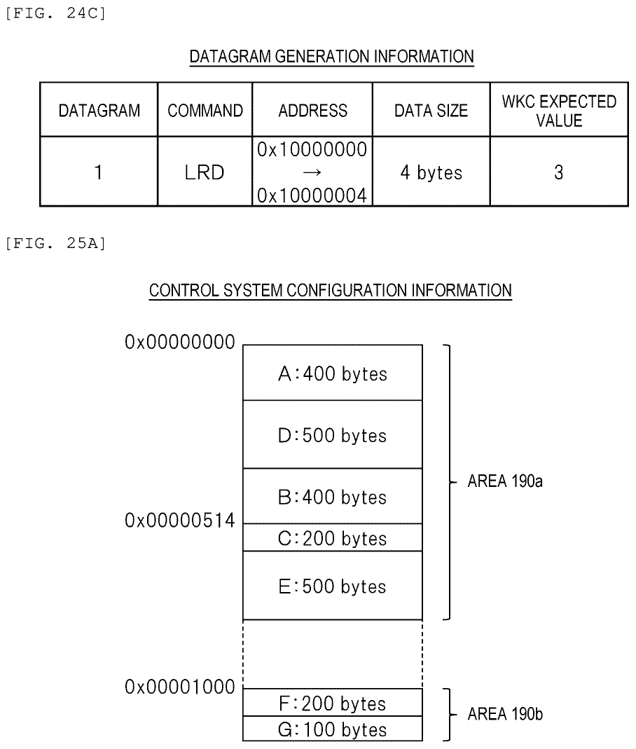

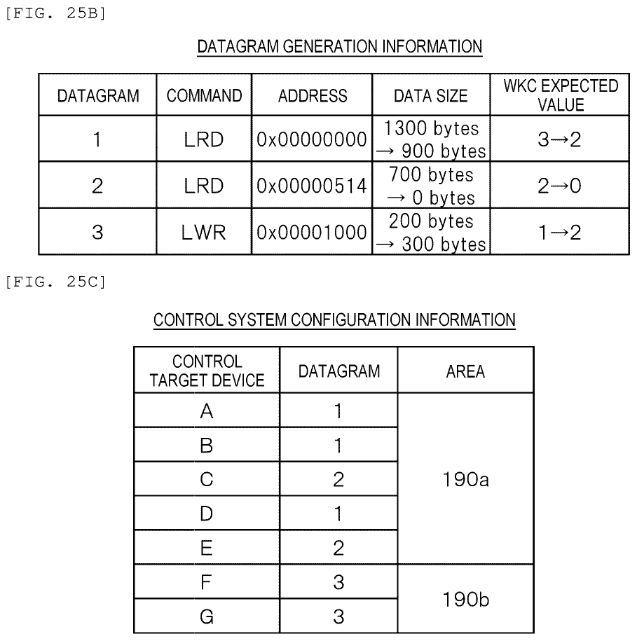

FIGS. 25A, 25B, and 25C are diagrams showing specific examples in which FIG. 14B, FIG. 14C, and FIG. 14D are changed, respectively. First, as a comparative example, in the configuration shown in FIG. 14A, the control target devices 121B, 121C, and 121E are removed, while the logical addresses of each control target device 121 are assigned in the connection order as shown in FIG. 14B. In this case, datagrams corresponding to the control target devices 121A, 121B, 121C, 121D, and 121E remain in the datagram [1] and the datagram [2] in both before and after the system configuration change.

Here, as shown in FIG. 25A, it is assumed that the control target device 121 to be changed is aggregated at the tail of the logical address space. Specifically, in FIG. 25A, unlike FIG. 14B, the control target devices 121B, 121C, and 121E to be removed are assigned to the tail of the area 190a, and the input and output of the control target device 121D are continuously assigned to the input and output of the control target device 121A.

Further, in step S002 shown in FIG. 8, it is assumed that the datagram generation information planning unit 111 plans the datagram generation information as shown in FIG. 25B. In FIG. 25B, the input and output of the control target devices 121A, 121D, and 121B are accessed by the datagram [1], and the input and output of the control target devices 121C and 121E are accessed by the datagram [2]. The datagram [1] may be assigned to access to the input and output of the control target devices 121A and 121D, and the datagram [2] may be assigned to access to the input and output of the control target devices 121B, 121C, and 121E. In any configuration, constraints of an upper limit size of the communication frame and the datagram are satisfied.

Under a premise of such a configuration, when the control target devices 121B, 121C, and 121E are removed as in the comparative example, in FIG. 25B, the datagram [1] can be left as is (however, the data size may be changed), and the datagram [2] can be invalidated because it is an access to the control target device 121 to be removed. That is, as compared with the case of using the datagram configuration shown in FIG. 14, the datagram number can be reduced from 3 (datagram [1], [2], [3]) to 2 (datagram [1], [3]).

Therefore, overhead of the Ethernet header 171, the header 176, the WKC 178, and the inter-frame gap can be reduced. That is, the input and output of the control target device 121 to be changed is continuously assigned to the head of the logical address space and the tail of the logical address space, and thus the use efficiency of the communication bandwidth can be improved when changing the system configuration.

### Application to Maximum Configuration for Temporary Operation

The control system 123 may operate with a temporary system configuration depending on the use. For example, when the control system 123 is in startup phase, all control target devices 121 may not be available, and the control system 123 may be implemented with only some of the control target devices 121. Alternatively, after the control system 123 is put into operation phase, there may be cases in which a sensor needs to be temporarily added to the control system 123 for monitoring and analysis in order to improve performance or to detect some malfunction.

In such a case, for example, the steps shown in FIG. 8 may be executed based on the control target device 121 group having a maximum configuration that can be taken by the control system 123. That is, the control system information storage unit 110 stores information f the control target device 121 group having the maximum configuration. Further, the datagram generation information planning unit 111, the logical address assignment planning unit 113, and the control system configuration information construction unit 112 execute, based on the control target device 121 group having the maximum configuration, planning of datagram generation information, assignment of logical addresses, and construction of control system configuration information, respectively.

For example, when the control system 123 is in startup phase, some of the control target devices 121 are not connected. In this state, executing the steps shown in FIG. 13 using a plan based on the control target device 121 group having the maximum configuration is equivalent to selecting and removing the control target device 121 that is not connected at the time of startup of the control system 123 in step S061 shown in FIG. 13. On the other hand, when monitoring and analysis are to be performed by temporarily adding a sensor after the control system 123 is put into operation phase, the step of FIGS. 8, 10, 11, 12, and 13 can be applied as it is because the control target device 121 group has the maximum configuration (when another control target device 121 is not involved).

As described above, by planning based on the maximum configuration of the control target device 121 group, the method of the embodiment can be applied even if all of the control target devices 121 are not available when the control system 123 is in startup phase, or when a sensor is temporarily added to the control system 123 for monitoring and analysis after the control system 123 is in operation phase. Then, effects similar to those of the method of the embodiment can be obtained.

### Automatic Recognition of Addition or Removal of Control Target Device 121

Addition and/or reduction of a control target device 121 manually by an operator or worker of the control system 123 may be implemented to recognize automatically. Specifically, in step S002 shown in FIG. 8, the datagram generation information planning unit 111 plans the datagram generation information of datagrams including commands to be responded by all the control target devices 121 in the control network 122. The datagram is used to automatically detect a change in the system configuration. Further, the control device 120 periodically transmits the datagram.

If such a datagram is constructed, a predetermined value is added to the value of the WKC 178 each time the datagram passes through each control target device 121, so that when the datagram is received by the control device 120, the value represents the total number of the control target devices 121. Therefore, the control device 120 observes the WKC 178 every time the datagram is received, and determines that the system configuration is changed when the value of the WKC 178 is changed (Y of step S060 shown in FIG. 13).

More specifically, when the value of the WKC 178 increases, the control device 120 can determine that the control target device 121 is newly added, and when the value of the WKC 178 decreases, the control device 120 can determine that the control target device 121 is removed. In such a case, in step S061, the control target device selection unit 160 accesses the control target devices 121 one by one using a command to access the auto-increment address or the station address predefined for each control target device 121, and identifies the control target device 121 that is changed. Thereafter, the step after step S062 may be executed based on the identified control target device 121.

In this case, when the comparison between the received value of the WKC 178 and the expected value is continued despite the addition or the removal of the control target device 121, the abnormality determination unit 163 determines that there is an abnormality. Therefore, in the case of automatically recognizing the addition or the removal of the control target device 121, for example, the comparison of the WKC 178 may not be executed by executing the step S063 immediately after the step S060. Alternatively, the abnormality determination unit 163 may determine that an abnormality occurs when a link connection in a physical layer can be confirmed but logical communication is not established.

### Collective Designation of Multiple Control Target Devices 121

In step S061, when selecting the control target devices 121, a plurality of control target devices 121 may be grouped in advance, and the control target devices 121 may be selected in units of groups. Alternatively, a pattern of a system configuration distinguished for each combination of the control target devices 121 that constitute the system may be defined in advance, and one may be selected from the pattern group in step S061. Any of these can be performed as a combination in which a single control target device 121 is selected and steps S062 to S066 are executed.

In addition, any one or more of steps S062, S063, S065, and S066 may be executed collectively for a group or pattern, and the remaining processing including step S064 may be executed for each of the control target devices 121 constituting the group or the pattern. Alternatively, in the selection of the control target device 121, a hierarchical structure may be constructed to refer to other groups or patterns within the definition of such a group or pattern.

As a specific implementation example, a selection method of the control target device 121 may be implemented by an HMI or a setting file of the control system management device 125 or the control device 120, and such group definition and pattern definition may be made in the HMI or the setting file. For example, a format such as XML or JSON may be used for such group definition and pattern definition. The group and pattern may include not only selection information of the control target device 121 but also information defining connection between the control target devices 121 and the network topology.

When the control target device 121 included in such a group or pattern is assigned to the logical address space, only a relative position to be assigned to the logical address space of each control target device 121 may be defined without fixing the start address position. In this case, the control target device selection unit 160 may determine a start address position of the group and the pattern when selecting the group and the pattern in step S061.

Regarding the selection and setting of the plurality of control target devices 121 such as the above groups and patterns, a similar mechanism may be applied not only to the step S061 shown in FIG. 13 but also to the planning by the datagram generation information planning unit 111 and the logical address assignment planning unit 113 in the step S002 shown in FIG. 8. That is, in step S002, when the datagram generation information planning unit 111 plans the datagram generation information, the datagram corresponding to the plurality of control target devices 121 designated by the group and the pattern may be collectively included in the group definition and the pattern definition.

For example, the control target device 121 included in the group or the pattern may be assigned to a continuous area in the logical address space, and a partial definition of a logical address command (for example, LRD) for accessing this may be included in the group definition and the pattern definition. Examples of such a partial definition include the size 182 included in the datagram header 176 and the expected value of the WKC 178 at the time of reception. As for the address 181, since it is determined when planning the datagram generation information, for example, the address may not be included in the group definition and pattern definition.

As exemplified in step S060 in FIG. 13, when the system configuration is automatically executed when a predetermined condition such as a predetermined timing or a predetermined cycle is satisfied, the system configuration after the change may be defined as a predetermined group or pattern definition. By defining the plurality of control target devices 121 in this way, the entire configuration of the control system 123 can be defined using the individual partial configuration. As a result, engineering man-hours related to the system configuration of the control system 123 can be reduced, and knowledge and know-how related to the system configuration can be accumulated by reusing partial definitions, resulting in the effect of improving the efficiency of system definition.

### Main Effects of First Embodiment

As described above, by using the method of the first embodiment, it is possible to implement a control system with excellent system adaptability, which is typically capable of changing the system configuration in response to a request to the control system while improving communication performance. Specifically, when a logical address space is used, as shown in FIGS. 9 and 14, communication can be performed collectively to the plurality of control target devices 121. For example, in FIG. 9C, only the datagram [1] can be accessed to the control target devices 121A, 121B, and 121C.

If the datagram can be aggregated in this manner, overhead on the communication called the header 176 or the WKC 178 can be reduced, and performance can be improved by improving use efficiency of a communication bandwidth and shortening a communication period. In this case, the number of communication frames can be reduced, and the overhead on communication associated with the Ethernet header 171 and the FCS 173 can be reduced.

Therefore, according to the above configuration, the performance of the control communication can be improved by utilizing the logical address. Further, it can also accommodate changes to the system configuration. That is, since the datagram generation information which is the expected value of the WKC 178 can be changed based on the control system configuration information, even after the system configuration is changed, abnormality determination by the abnormality determination unit 163 and retransmission by the retransmission unit 164 can be appropriately executed. In this way, the control system 123 can be highly reliable by appropriately performing the abnormality determination, the abnormality notification, and the retransmission processing according to the configuration change in the control system 123.

Since the datagram generation information such as the WKC 178 is appropriately changed in response to changes in the system configuration, it is possible to distinguish between the abnormality in a communication path and changes in the number of the control target devices 121 as the changes in the system configuration, and the abnormality in the communication path can be detected without erroneous determination. That is, when the expected value of the WKC 178 is not changed in conjunction with a change in the system configuration, an mismatch between the received value of the WKC 178 and the expected value will occur, and it may be erroneously determined that an abnormality occurs in the communication path.

When the control target device 121 is accessed using the logical address, the communication with the control target device 121 is possible regardless of the position of the control target device 121 on the network. Therefore, even if there is a change in a communication topology, such as a replacement of a communication cable between the control target devices 121, or a change in the connection order of the control target devices 121, it is possible to achieve both improvement in performance of the control communication by using the logical address and supporting a change in the system configuration.

There is a degree of freedom in assigning the inputs and output of the control target device 121 to the logical address space, so that the assignment can be flexibly performed according to a request from the control system 123. In the embodiment, the assignment of the input and output of the control target device 121 to the logical address space is managed as the control system configuration information, so that the assignment of a specific logical address space is not limited, and the control system can be changed while maintaining the degree of freedom and flexibility of the assignment of the logical address space.

While the flexibility of the configuration change of the control system 123 is secured, the period of the control communication can be shortened by improving the communication performance by utilizing the logical address space. If the period of the control communication can be shortened, the control period of the control system 123 can be shortened, and as a result, the control performance of the control system 123 can be improved. Other communication such as a setting and a state acquisition can be executed by utilizing the surplus communication bandwidth, and can be utilized for maintenance and diagnosis by visualization of the control target device 121 and the control system 123 and utilization of IoT. Therefore, the operation of the control system 123 can be leveled up, and performance and an operating rate of the control system can be improved.

### Second Embodiment

A second embodiment is different from the first embodiment in terms of abnormality determination of a communication path and cable redundancy.

### Hardware Structure of Control Device 120 in Cable Redundancy

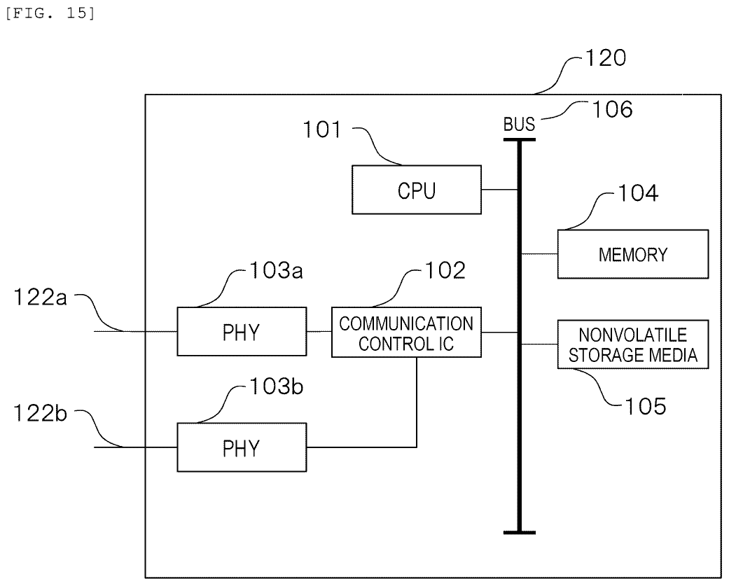

FIG. 15 is a block diagram showing a hardware structure example of the control device 120 in FIG. 1 in a control communication system according to a second embodiment. In the control device 120 shown in FIG. 15, unlike the configuration example shown in FIG. 2, in order to cope with the cable redundancy, the communication control IC 102 is connected to a plurality of (two in this example) PHYS 103a and 103b.

### Functional Configuration of Control Device 120 in Cable Redundancy

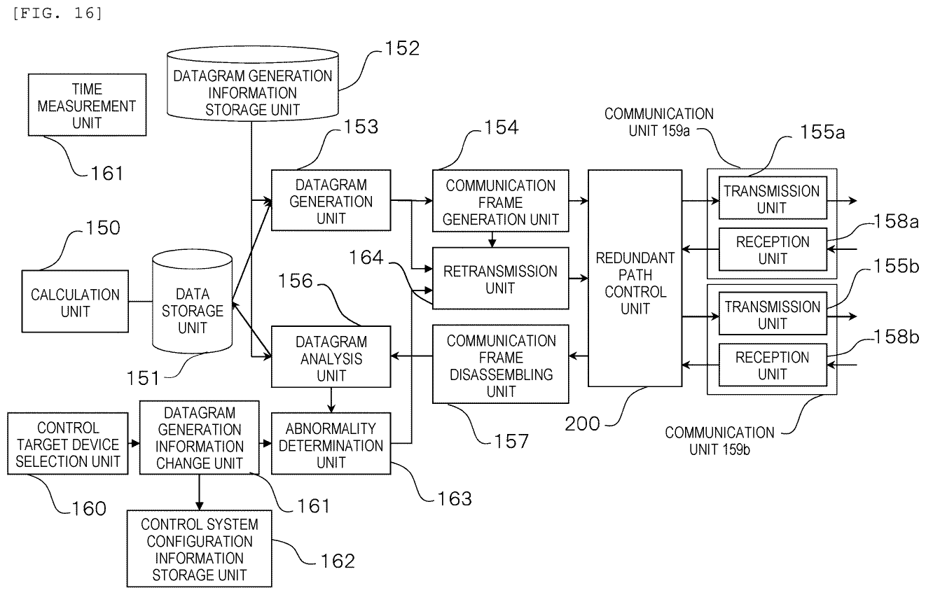

FIG. 16 is a functional block diagram showing a functional configuration example of the control device 120 shown in FIG. 15. In FIG. 16, a redundant path control unit 200, which is a functional unit that controls path redundant communication, is provided to the configuration example of FIG. 3. The redundant path control unit 200 replicates a communication frame transferred from the communication frame generation unit 153 and transmits the communication frame to a transmission unit 155a and a transmission unit 155b or simply transmits the communication frame to the transmission unit 155a.

The redundant path control unit 200 transfers communication frames received from a reception unit 158a and a reception unit 158b to the communication frame disassembling unit 157 or the transmission unit 155b. The redundant path control unit 200 combines the contents received from the reception unit 158a and the reception unit 158b as necessary. The combination refers to, for example, taking a logical OR of contents received by logical address read (LRD) or broadcast read (BRD).

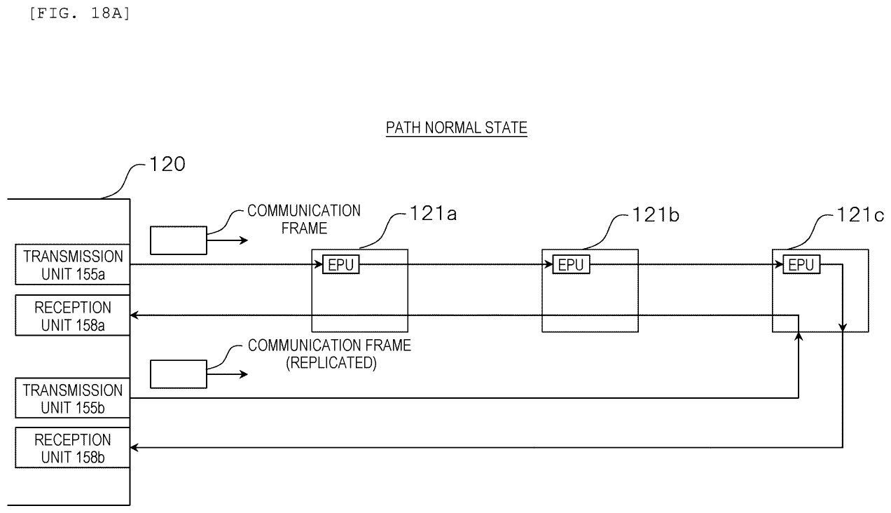

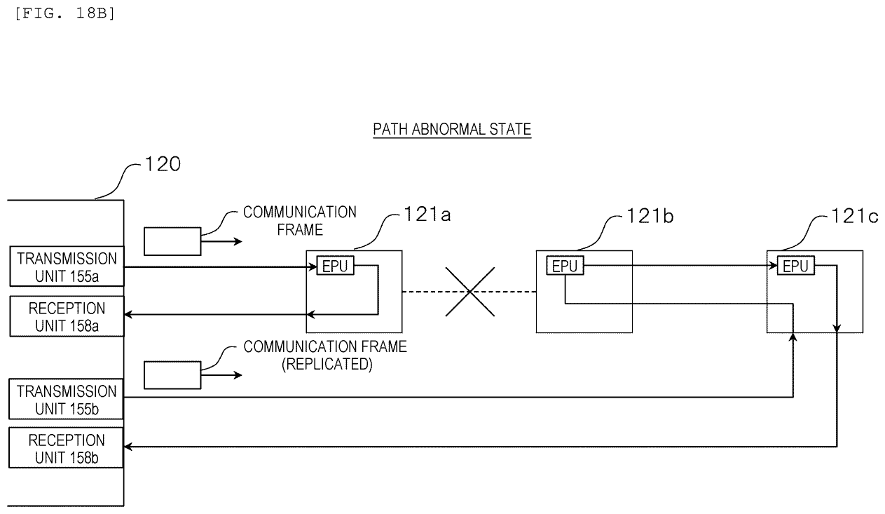

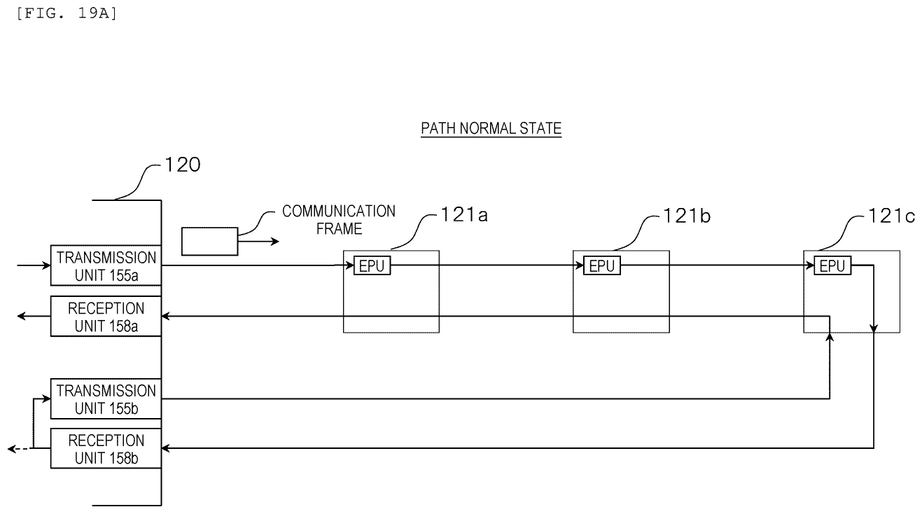

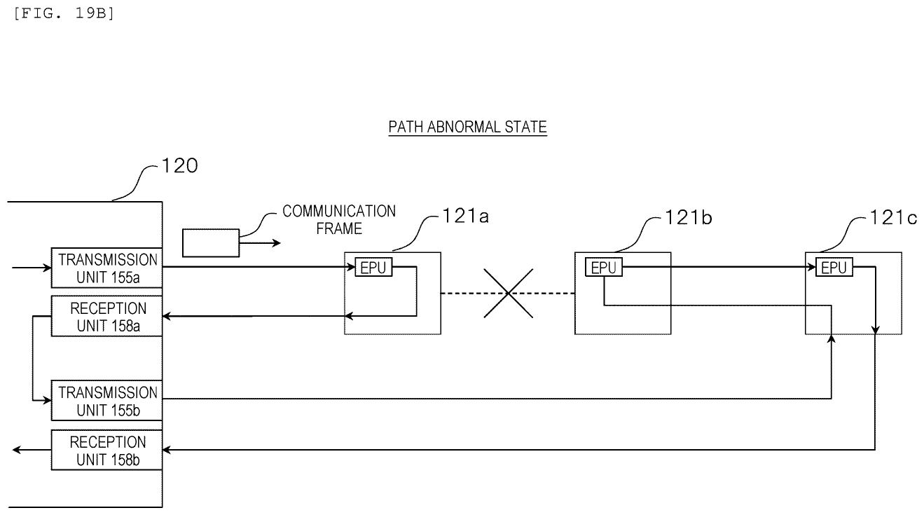

For example, the redundant path control unit 200 is implemented by one of the CPU 101 or an application operating on the CPU 101, and the communication control IC 102, or a plurality thereof. By using the functional configuration shown in FIG. 16, it is possible to determine whether there is an abnormality in the communication path in the control network 122 and an occurrence location of the abnormality, and to improve reliability of communication by using a redundant communication path, as will be described in detail later. The communication method using the redundant path includes two methods as shown in FIGS. 18 and 19.

### Redundant Communication According to Replication Method

FIGS. 18A and 18B are schematic diagrams showing an example of a communication method using a redundant path in the control communication system according to the second embodiment. In FIG. 18, the redundant path control unit 200 replicates a communication frame transferred from the communication frame generation unit 154, and the communication frame is transmitted from both of the transmission unit 155a and transmission unit 155b.

In a normal state shown in FIG. 18A, the communication frame transmitted from the transmission unit 155a is received by the reception unit 158b via the control target devices 121a, 121b, and 121c in this order. A communication frame transmitted from the transmission unit 155b is received by the reception unit 158a via the control target devices 121c, 121b, and 121a in this order. On the other hand, when a path abnormality occurs as shown in FIG. 18B, the communication frame transmitted from the transmission unit 155a is returned by the control target device 121a and then received by the reception unit 158a. A communication frame transmitted from the transmission unit 155b is returned by the control target device 121b and then received by the reception unit 158b.

### Redundant Communication According to Forwarding Method

FIGS. 19A and 19B are schematic diagrams showing an example of another communication method using a redundant path in the control communication system according to the second embodiment. In FIG. 19, a communication frame transferred from the communication frame generation unit 154 is transmitted from the transmission unit 155a, and the redundant path control unit 200 switches a transfer destination of the communication frame at the time of reception according to a state of a path.

In a normal path state shown in FIG. 19A, the communication frame transmitted from the transmission unit 155a is received by the reception unit 158b via the control target devices 121a, 121b, and 121c in this order. The redundant path control unit 200 transfers the communication frame received by the reception unit 158b to the transmission unit 155b. Thereafter, the communication frame transmitted from the transmission unit 155b is received by the reception unit 158a via the control target devices 121c, 121b, and 121a in this order. The redundant path control unit 200 transfers the communication frame received by the reception unit 158a to the communication frame disassembling unit 157. The communication frame received by the reception unit 158b passes through EPU of all of the control target devices 121. Therefore, the redundant path control unit 200 may transfer the communication frame to the communication frame disassembling unit 157 without transferring the communication frame to the transmission unit 155b.

On the other hand, when a path abnormality occurs as shown in FIG. 19B, the communication frame transmitted from the transmission unit 155a is returned by the control target device 121a and then received by the reception unit 158a. The redundant path control unit 200 transfers the communication frame received by the reception unit 158b to the transmission unit 155b. A communication frame transmitted from the transmission unit 155b is returned by the control target device 121b and then received by the reception unit 158b. The redundant path control unit 200 transfers the communication frame received by the reception unit 158b to the communication frame disassembling unit 157.

The redundant path control unit 200 stores information for identifying the communication frame, and stores the information together with the processing performed on the communication frame (transmission by the transmission unit 155a, the transmission unit 155b, reception by the reception unit 158a, the reception unit 158b, and transfer to the transmission unit 155b), thereby making it possible to determine the processing to be performed when the communication frame is received. Examples of information for identifying a communication frame include information on the communication frame (parameters such as a size, a datagram number, and a command for each datagram), the time when the frame is transferred from the communication frame generation unit 154 to the redundant path control unit 200, the time when the frame is transmitted from the transmission unit 155a and the transmission unit 155b, and the time when the frame is received by the reception unit 158a and the reception unit 158b.

### Transmission Processing Step for Cable Redundancy

The execution step of the transmission processing in the control device 120 at the time of cable redundancy is substantially the same as that in FIG. 10. However, in the case of the replication method shown in FIG. 18, in step S019, the redundant path control unit 200 replicates the communication frame transferred from the communication frame generation unit 154 and transfers the communication frame to both the transmission unit 155a and the transmission unit 155b. Then, the transmission unit 155a and the transmission unit 155b transmit the transferred communication frame.

On the other hand, in the case of the forwarding method shown in FIG. 19, in step S019, the redundant path control unit 200 selects one of the transmission unit 155a and the transmission unit 155b and transmits the communication frame via the selected transmission unit 155. At this time, the redundant path control unit 200 may always select either the transmission unit 155a or the transmission unit 155b in a fixed manner, or may select based on an operational history, such as a past communication amount (a total size of transmitted packets), the number of transmissions, or the transmission unit 155 different from the transmission unit 155 used in the previous transmission.

At this time, the redundant path control unit 200 may reflect an identifier of the selected transmission unit 155 on the datagram or the communication frame to be transmitted as a record of the processing (transmission by the transmission unit 155a or the transmission unit 155b) performed on the datagram or the communication frame. For example, information on the processing to be performed may be reflected in a destination MAC address of the Ethernet header 171, and the index 180 of a head datagram. For example, the information on the presence or absence of transmission by the transmission unit 155a and the information on the presence or absence of transmission by the transmission unit 155b can be represented by one bit, and one example is that either or both of these are reflected on a datagram or a communication frame (in this case, information “1” indicates the presence of the corresponding event).

### Reception Processing Step for Cable Redundancy

The execution step of the reception processing in the control device 120 at the time of cable redundancy is substantially the same as that in FIG. 11. However, in step S030, when the reception unit 158a or the reception unit 158b receives the communication frame, it transfers the communication frame to the communication frame disassembling unit 157 via the redundant path control unit 200.

In the case of the replication method shown in FIG. 18, for example, the processing proceeds to step S031 after both the reception unit 158a and the reception unit 158b receive the communication frame. At this time, the redundant path control unit 200 combines the data areas of the datagram in the received communication frame based on the logical OR, and/or sums the respective WKCs 178 and transfers the result to the communication frame disassembling unit 157. More specifically, the redundant path control unit 200 may change the processing of the communication frame depending on the command of the reception datagram. For example, if the command is an LRD command or a BRD command, it may combine the commands using a logical OR, but if the command is another command such as an APRD command, it may not be combined and may be transferred sequentially to the communication frame disassembling unit 157.

Similarly, with regard to the WKC 178, the redundant path control unit 200 may sum the WKCs 178 if the command is one that can access a plurality of slaves, such as the LRD or the BRD, and may transfer the WKC 178 of the datagram as it is if the command is one that can access a single slave, such as an ARPD command. Alternatively, the redundant path control unit 200 may select only a first-arrived communication frame or only a later-arrived communication frame and transfer it to the communication frame disassembling unit 157. The communication frame disassembling unit 157 or the data storage unit 151 may perform the combination (a logical OR or selection of a communication frame) for each datagram.

In the case of the forwarding method shown in FIG. 19, the processing may proceed to step S031 when a communication frame is received by one of the reception unit 158a and the reception unit 158b in step S030 shown in FIG. 11. In the case of the forwarding method shown in FIG. 19, or in both the step S039 and step S043, the redundant path control unit 200 may reflect the identifier of the reception unit 158 that receives the datagram or the communication frame as a record of the processing performed on the received communication frame (reception at the reception unit 158a or the reception unit 158b).

For example, information on the processing to be performed may be reflected in a destination MAC address of the Ethernet header 171, and the index 180 of a head datagram. For example, the information on the presence or absence of reception by the reception unit 155a and the information on the presence or absence of reception by the reception unit 155b can be represented by one bit, and one example is that either or both of these are reflected in the communication frame (in this case, information “1” indicates the presence of the corresponding event).

### Abnormality Determination and Corresponding Step

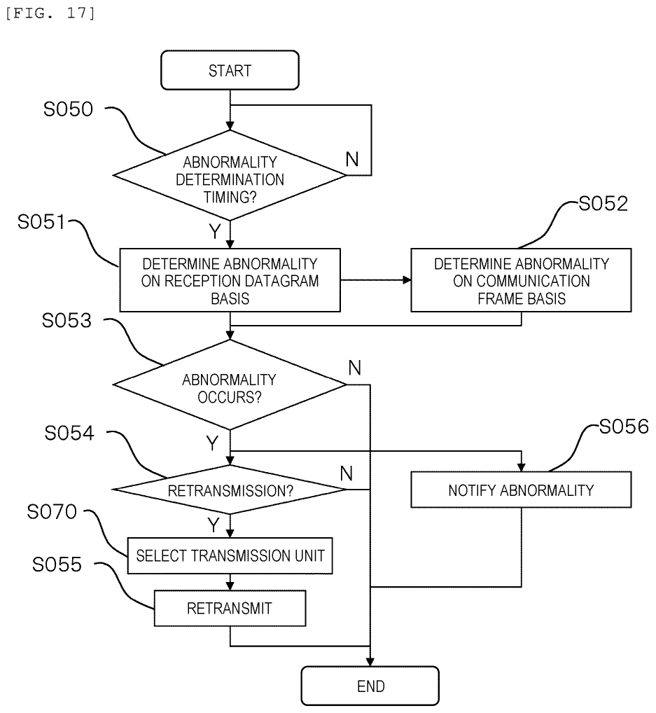

FIG. 17 is a flowchart showing an example of the abnormality determination processing performed by the abnormality determination unit 163 shown in FIG. 16 and an execution step of the abnormality corresponding processing performed by the retransmission unit 164 and the redundant path control unit 200. Step shown in FIG. 17 correspond to steps S035, S041, S042 in FIG. 11. The steps shown in FIG. 17 are basically the same as that of FIG. 12, but differ from FIG. 12 in some details of the steps.

First, it is assumed that the replication method shown in FIG. 18 is used. In this case, in the abnormality determination in step S051 or step S052 shown in FIG. 17, the abnormality determination unit 163 compares the value obtained by summing the values of the WKC 178 of the datagram received by each of the reception unit 158a and the reception unit 158b with the expected value of the datagram generation information, and determines that there is an abnormality when the values are not equal. Next, it is assumed that the forwarding method shown in FIG. 19 is used. In this case, in the abnormality determination in step S051 or step S052, the abnormality determination unit 163 determines the abnormality based on the execution processing for the received datagram or communication frame.

As a specific example, when a communication frame is received by the reception unit 158a, when the communication frame stores information indicating that it is transmitted from the transmission unit 155a, received by the reception unit 158b, and then transmitted from the transmission unit 155b, the abnormality determination unit 163 can determine that the processing is performed in a normal path shown in FIG. 19A. On the other hand, when the communication frame is received by the reception unit 158a, when the communication frame stores information indicating only that the communication frame is transmitted from the transmission unit 155a, the abnormality determination unit 163 can determine that the processing is performed due to a path abnormality as shown in FIG. 19B, and can determine that there is an abnormality.

It is assumed that when a communication frame is received by the reception unit 158a, information indicating that the communication frame is transmitted from the transmission unit 155a, received by the reception unit 158a, and transmitted from the transmission unit 155b is stored in the communication frame. In this case, the abnormality determination unit 163 can determine that the path abnormality shown in FIG. 19B temporarily occurs, and that when the transmission is performed from the transmission unit 155b, the communication path is normal and the communication frame is received by the reception unit 158a. In such a case, since it can be determined that communication with the control target devices 121b and 121c is not possible, for example, processing such as discarding the communication frame or retransmitting the communication frame (step S055 shown in FIG. 17) is executed.

In FIG. 17, unlike FIG. 12, when the abnormality determination unit 163 determines to perform retransmission in step S054 (Y in step S054), the redundant path control unit 200 selects the transmission unit 155 via the retransmission unit 164 (step S070). For example, in the replication method shown in FIG. 18, the redundant path control unit 200 selects both the transmission unit 155a and the transmission unit 155b.

On the other hand, in the forwarding method shown in FIG. 19, the redundant path control unit 200 may select the transmission unit 155 in the same manner as in step S019 shown in FIG. 10 in the following cases.
When the value of the WKC 178 at the time of receiving the datagram is not equal to the expected value defined in the datagram generation information
When a format of the received datagram is not match the format defined by a communication protocol
When a timeout value elapses
When an abnormality is detected in the cyclic redundancy check using the FCS 173 in the received communication frame

In addition, the redundant path control unit 200 may select the transmission unit 155 in the same manner as in step S019 shown in FIG. 10 in the following cases.
When a communication abnormality is detected when accessing an area of the data storage unit 151
When an access abnormality is detected in the memory 104 and the nonvolatile storage media 105 which implement the data storage unit 151
When a soft error is detected in the communication control IC 102, the memory 104, and the nonvolatile storage media 105 implemented as the calculation means and the storage means of the functional unit
When an abnormality or the like occurs in step S038 in FIG. 11

Alternatively, the redundant path control unit 200 may select the transmission unit 155 based on the execution processing for the received datagram or communication frame. For example, when the reception unit 158a receives a communication frame, when there is a record of the communication frame only being transmitted from the transmission unit 155a or there is no record of the communication frame being received by the reception unit 158b, the abnormality determination unit 163 or the redundant path control unit 200 can determine that there is a path abnormality as shown in FIG. 19B. Therefore, the redundant path control unit 200 selects the transmission unit 155b (step S070 shown in FIG. 17) and retransmits the communication frame (step S055 shown in FIG. 17).

For example, it is assumed that when a communication frame is received by the reception unit 158a, there is a record that indicates that the communication frame is transmitted from the transmission unit 155a, received by the reception unit 158a, and then transmitted from the transmission unit 155b. In this case, the abnormality determination unit 163 and the redundant path control unit 200 can determine that the path abnormality shown in FIG. 19B temporarily occurs, and that when the transmission is performed from the transmission unit 155b, the communication path is normal and the communication frame is received by the reception unit 158a.

Accordingly, since it can be determined that communication with the control target devices 121b and 121c is not possible, for example, processing such as discarding the communication frame and retransmitting the communication frame is executed. At this time, the redundant path control unit 200 may select the transmission unit 155 used for retransmission in the same manner as in step S019 shown in FIG. 10. With this configuration, even when a path abnormality temporarily occurs, it is possible to prevent a communication frame from overflowing onto the control network 122 (occurrence of flooding), and it is possible to stably operate the control system 123.

### Determination of Abnormality Location

In order to determine the abnormality location, in step S002 shown in FIG. 8, the datagram generation information planning unit 111 may plan the datagram generation information of datagrams including commands to be responded by all the control target devices 121 in the control network 122. If a datagram is constructed that includes a command to which all of the control target devices 121 respond, the value of the WKC 178 is added by a predetermined value each time the datagram passes through each control target device 121. Accordingly, the abnormality determination unit 163 can determine the abnormality location at the time of the path abnormality. Hereinafter, a datagram including a command to which all the control target devices 121 respond is referred to as an abnormality detection datagram, and a method for determining the abnormality location will be described in detail.

The expected value of the WKC 178 of the abnormality detection datagram is the same as the total number of the control target devices 121 constituting the control system 123. Examples of the abnormality detection datagram include broadcast commands (BRD, BWR, BRW) to a common register of all the control target devices 121, and logical address access commands (LRD, LWR, LRW) to a common logical address assignment set in all the control target devices 121.

For example, when the communication frame transmitted from the transmission unit 155a is received by the reception unit 158b at the time of normal path shown in FIG. 18A, the value of the WKC 178 of the abnormality detection datagram is 3 (in the case of a read or write command, not a read and write command). When the communication frame transmitted from the transmission unit 155b is received by the reception unit 158a, the value of the WKC 178 of the abnormality detection datagram is 0.

On the other hand, when the communication frame transmitted from the transmission unit 155a is received by the reception unit 158a at the time of the path abnormality shown in FIG. 18B, the value of the WKC 178 of the abnormality detection datagram is 1 (in the case of a read or write command, not a read and write command) because the control target device 121a responds. When the communication frame transmitted from the transmission unit 155b is received by the reception unit 158b, the value of the WKC 178 of the abnormality detection datagram is 2 because the control target devices 121b and 121c respond.

### When the Communication Frame Transmitted From the

transmission unit 155a is received by the reception unit 158b at the time of normal path shown in FIG. 19A, the value of the WKC 178 of the abnormality detection datagram is 3 (in the case of a read or write command, not a read and write command). On the other hand, when the communication frame transmitted from the transmission unit 155a is received by the reception unit 158a at the time of the path abnormality shown in FIG. 19B, the value of the WKC 178 of the abnormality detection datagram is 1 (in the case of a read or write command, not a read and write command) because the control target device 121a responds. Thereafter, when the communication frame received by the reception unit 158a is transferred to the transmission unit 155b and transmitted, and the transmitted communication frame is received by the reception unit 158b, the value of the WKC 178 of the abnormality detection datagram is 3 because the control target devices 121b and 121c additionally respond.

That is, in the case of the replication method shown in FIG. 18 in step S051 shown in FIG. 17, the abnormality determination unit 163 can determine a path abnormality location based on the value of the WKC 178 of the abnormality detection datagram received by the reception unit 158a and the reception unit 158b. For example, in the case of FIG. 18B, since the values of the WKC 178 of the abnormality detection datagram received by the reception unit 158a and the reception unit 158b are 1 and 2, respectively, it can be determined that the path abnormality location is the communication path between the control target device 121a and the control target device 121b.

Similarly, in the case of the forwarding method shown in FIG. 19 in step S051 shown in FIG. 17, the abnormality determination unit 163 can determine the path abnormality location based on the value of the WKC 178 of the abnormality detection datagram received by the reception unit 158a. For example, in the case of FIG. 19B, since the value of the WKC 178 of the abnormality detection datagram received by the reception unit 158a is 1, it can be determined that the path abnormality location is the communication path between the control target device 121a and the control target device 121b.

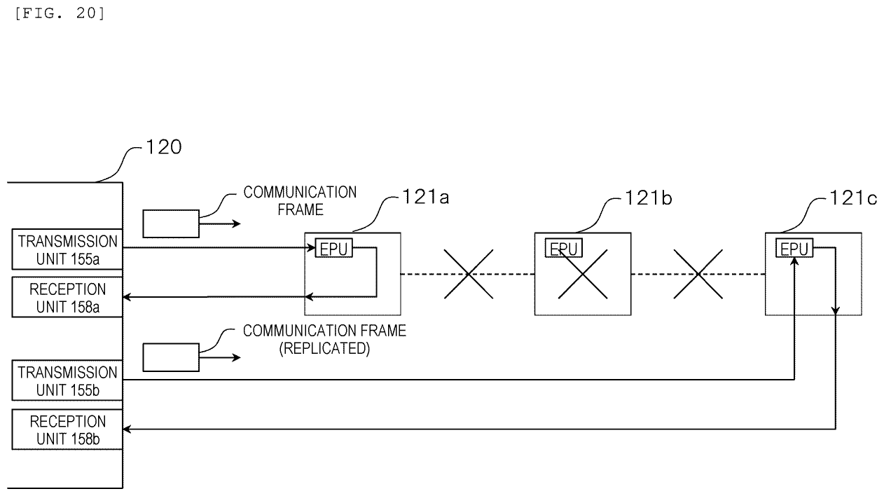

Further, by using the total number of values of the WKC 178 in the replication method or the value of the WKC 178 after transfer in the forwarding method, it is possible to determine whether there are two or more path abnormality locations or whether there is a failure in the control target device 121. FIG. 20 is a diagram showing an example of a communication path when path abnormalities occur at a plurality of locations or a failure occurs in the control target device 121 in the replication method shown in FIG. 18. In FIG. 20, two locations of path abnormality or a failure of one control target device 121b occurs.

In this case, the values of the WKC 178 of the abnormality detection datagram received by the reception unit 158a and the reception unit 158b are 1 according to the response of the control target device 121a and 1 according to the response of the control target device 121c, respectively. Therefore, the total value of the values of the WKC 178 is 2. By determining in advance in the control device 120 that the total number of the control target devices 121 is 3, in the case of FIG. 20, this total number is not equal to the total value of the received WKCs 178.

Therefore, the abnormality determination unit 163 can determine that there are two or more path abnormality locations or that there is a failure in one of the control target devices 121. Further, based on the value of the WKC 178, the abnormality determination unit 163 can determine that the occurrence locations of the abnormality are two path locations, the path between the control target device 121a and the control target device 121b and the path between the control target device 121b and the control target device 121c, or that there is a failure in the control target device 121b, or both.

The value of the WKC 178 of the abnormality detection datagram received by the reception unit 158a and the reception unit 158b is the number of the EPUs passed by the abnormality detection datagram transmitted from the transmission unit 155a and the transmission unit 155b. Therefore, as described above, the value of the WKC 178 of the abnormality detection datagram received by each reception unit 158 can be used to determine the control target device 121 that can be reached from each transmission unit 155, and ultimately, the occurrence location of the path abnormality or the control target device 121 that is unable to communicate can be identified.

FIG. 21 is a diagram showing an example of the communication path when the path abnormalities or failures in the control target device 121 occur at the plurality of locations in the forwarding method shown in FIG. 19. In FIG. 21, a path abnormality or a failure in the control target device 121b occurs at the same location as in FIG. 20. In this case, the values of the WKC 178 of the abnormality detection datagrams received by the reception unit 158a and the reception unit 158b become 1 due to the response from the control target device 121a and 2 due to the additional response from the control target device 121c, respectively.

By determining in advance in the control device 120 that the total number of control target devices 121 is 3, in the case of FIG. 21, the total number is not equal to the value of the WKC 178 received by the reception unit 158b. Therefore, the abnormality determination unit 163 can determine that there are two or more path abnormality locations or that there is a failure in one of the control target devices 121. Further, based on the value of the WKC 178, the abnormality determination unit 163 can determine that the occurrence locations of the abnormality are two path locations, the path between the control target device 121a and the control target device 121b and the path between the control target device 121b and the control target device 121c, or that there is a failure in the control target device 121b, or both.

The value of the WKC 178 of the abnormality detection datagram received by the reception unit 158a is the number of datagrams transmitted from the transmission unit 155a that passes through the EPU. On the other hand, the value of the WKC 178 of the abnormality detection datagram received by the reception unit 158b is the sum of the number of datagrams transmitted from the transmission unit 155a that passes through the EPU and the number of datagrams transmitted from the transmission unit 155b that passes through the EPU. Therefore, as described above, the value of the WKC 178 of the datagram received by each reception unit 158 can be used to determine the control target device 121 that can be reached from each transmission unit 155, and ultimately, the occurrence location of the path abnormality or the control target device 121 that is unable to communicate can be identified.

In step S056 shown in FIG. 17, when the abnormality determination unit 163 determines that an abnormality occurs in the communication path, the abnormality determination unit 163 notifies the calculation unit 150 of information related to the abnormality. Examples of the information related to the abnormality include, in addition to the information notified in step S056 described in FIG. 12, the communication path in which it is determined that a path abnormality occurs, specifically, an identifier 0 f the control target device 121 adjacent to the communication path, or an identifier of the control target device 121 in which it is determined that a failure occurs. In the example shown in FIG. 20 or FIG. 21, the identifier of the control target device 121b is notified to the calculation unit 140.

### When Abnormality Occurs in Communication Path Connecting to Control Device 120

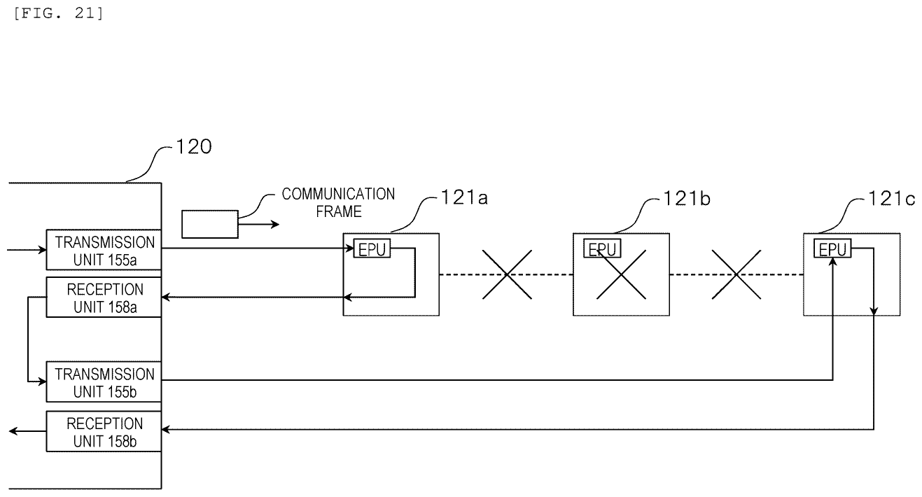

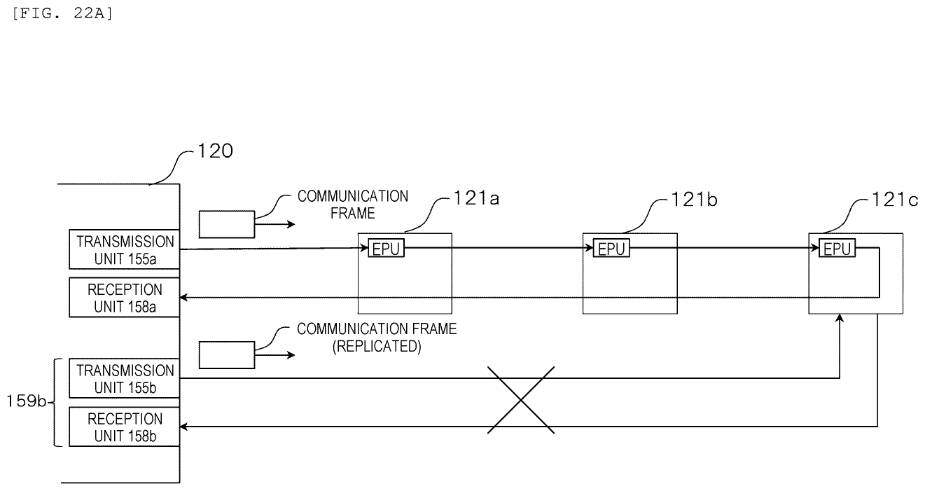

FIG. 22A is a diagram showing an example of a communication path when an abnormality occurs in a communication path adjacent to the control device 120 in the replication method shown in FIG. 18. In FIG. 22A, a path abnormality occurs between the control device 120 and the control target device 121c. When such a path abnormality occurs, the transmission unit 155b does not transmit the communication frame and loops back the communication frame by detecting the abnormality of the communication path in a communication unit 159b. As a result, it is the same as received by the reception unit 158b. Therefore, the value of the WKC 178 of the abnormality detection datagram received by the reception unit 158a of the communication path is 3, and the value of the WKC 178 of the abnormality detection datagram received by the reception unit 158b is 0.

On the other hand, if there is no abnormality in the communication path of the control network 122, the reception unit 158a receives the abnormality detection datagram transmitted from the transmission unit 155b as shown in FIG. 18A, and thus the value of the WKC 178 of the abnormality detection datagram received by the reception unit 158a is 0. In FIG. 22A, since the value of the WKC 178 of the abnormality detection datagram is 0, the abnormality determination unit 163 can determine that an abnormality occurs in the communication path. On the other hand, since the total number of the control target devices 121 is 3 and the value of the WKC 178 of the abnormality detection datagram received by the reception unit 158 a is 3, the abnormality determination unit 163 can determine that the communication frame transmitted from the transmission unit 155a passes through the EPU of all the control target devices 121.

Therefore, in such a case, in step S030 shown in FIG. 11, the redundant path control unit 200 may proceed the processing to step S031 without waiting for the reception of the communication frame in the reception unit 158b. Therefore, for example, the redundant path control unit 200 transfers the communication frame to the communication frame disassembling unit 157 without combining the data areas of the datagrams in the received communication frame by logical OR and without adding the values of the WKC 178 of the datagrams.

FIG. 22B is a diagram showing an example of a communication path when an abnormality occurs in a communication path adjacent to the control device 120 in the forwarding method shown in FIG. 19. In FIG. 22B, a path abnormality occurs at the same position as in FIG. 22A. When such a path abnormality occurs, the value of the WKC 178 of the abnormality detection datagram received by the reception unit 158a is 3. On the other hand, based on a processing history associated with the received communication frame, if there is no forwarding to the transmission unit 155b, transmission from the transmission unit 155b, or reception at the reception unit 158b as shown in FIG. 19A, it can be determined that the communication frame is received by the reception unit 158a after being transmitted from the transmission unit 155a.

Therefore, the abnormality determination unit 163 can determine that an abnormality occurs in the communication path. On the other hand, since the total number of the control target devices 121 is 3 and the value of the WKC 178 of the abnormality detection datagram received by the reception unit 158a is 3, the abnormality determination unit 163 can determine that the communication frame transmitted from the transmission unit 155a passes through the EPU of all the control target devices 121.

Therefore, in such a case, in step S053 shown in FIG. 17, the abnormality determination unit 163 determines that retransmission is unnecessary (N in step S053), and does not need to transfer to the transmission unit 155b. That is, in step S056 shown in FIG. 17, the abnormality determination unit 163 may notify the calculation unit 150 or the like of information on a communication path adjacent to the control device 120 that is the occurrence location of the path abnormality. However, in step S035 shown in FIG. 11, the abnormality determination unit 163 may determine that there is no abnormality in the reception datagram (N in step S035), proceed the processing to step S036, and then in steps S037 and S038, processing of recording the reception data in the data storage unit 151 may be performed.

### Change in Total Number of Control Target Devices 121 When Changing System Configuration

As described above, in the cable redundancy, the contents of the determination and the processing may vary depending on the total number of the control target devices 121 in the control system 123. Therefore, in the control device 120, for example, the total number of the control target devices 121 is stored in the datagram generation information storage unit 152, the control system configuration information storage unit 162, or a functional unit (not shown).

In addition, in the change step of the system configuration change shown in FIG. 13, the control target device selection unit 160 selects the control target device 121 to be changed in step S061, and the datagram generation information change unit 161 changes total number information of the control target devices 121 in step S064. In this case, for example, the total number information of the control target devices 121 included in a group or a pattern may be included in the group or the pattern definition that designates a plurality of control target devices 121. In this case, the control target device selection unit 160 may change the total number of the control target devices 121 by using the total number information when the group and the pattern are selected in step S061.

Even when the system configuration is changed, by changing the total number of the control target devices 121, it is possible to appropriately execute the cable redundancy according to the total number of the control target devices 121, thereby making the control system 123 highly reliable. According to the high reliability of the control system 123, it is possible to obtain the effect of improving an operating rate and improving productivity by the control system 123.

### Main Effects of Second Embodiment

As described above, by using the method according to the second embodiment, it is possible to obtain the effects same as those described in the t first embodiment. In addition, the occurrence location of the abnormality or the failure can be identified based on the value of the WKC 178, and in particular, even when the system configuration is changed, the occurrence location of the abnormality or the failure can be identified by changing the total number of the control target devices 121. As a result, a control system having excellent system adaptability can be implemented.

### Third Embodiment

A third embodiment is different from the first embodiment and second embodiment in that the same logical address is assigned to a plurality of control target devices 121, and the logical address is changed when the system configuration is changed. When the cable redundancy is used for the premise of the problem, the path changes depending on an abnormality situation, which can make time synchronization difficult. Therefore, the time synchronization can be achieved even at the time of abnormality occurrence, and a mechanism capable of coping with a change in the system configuration is required.

### Compatibility Between Cable Redundancy and Time Synchronization

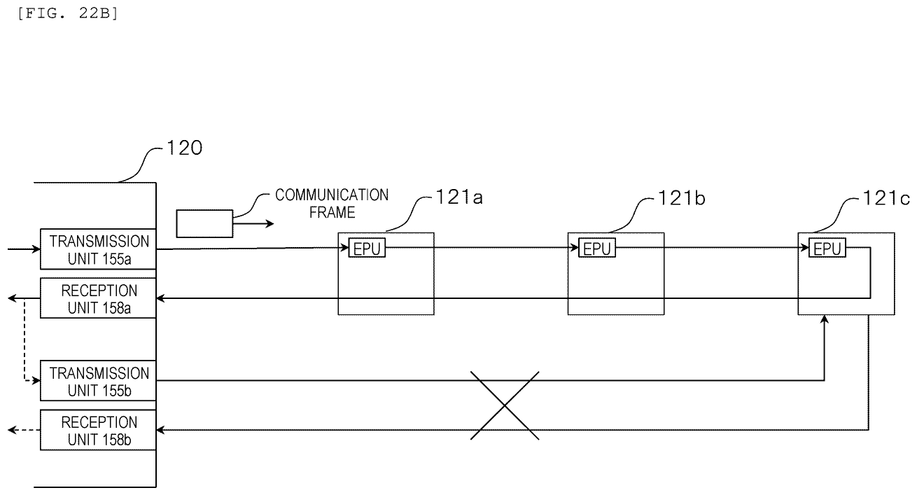

FIG. 23 is a schematic diagram showing an operation example when the same logical address is assigned to and read from a plurality of control target devices 121 after applying cable redundancy as a premise of a control communication system according to the third embodiment. In FIG. 23, the forwarding method shown in FIG. 19 is applied. The logical address space has a feature that when the same address is assigned to a plurality of control target devices 121 and read, the information of the last accessed logical address is read.

In FIG. 23, the control target devices 121a, 121b, and 121c are assigned to 4 byte spaces starting from the same logical address 0x10000000, and store different data 0, 1, and 2, respectively. In FIG. 23, an abnormality occurs in the communication path between the control target device 121a and the control target device 121b. In this case, the read command to the logical address 0x10000000 transmitted from the transmission unit 155a is received by the reception unit 158a, and the data 0 stored by the control target device 121a is stored in the data area 177 in FIG. 4.

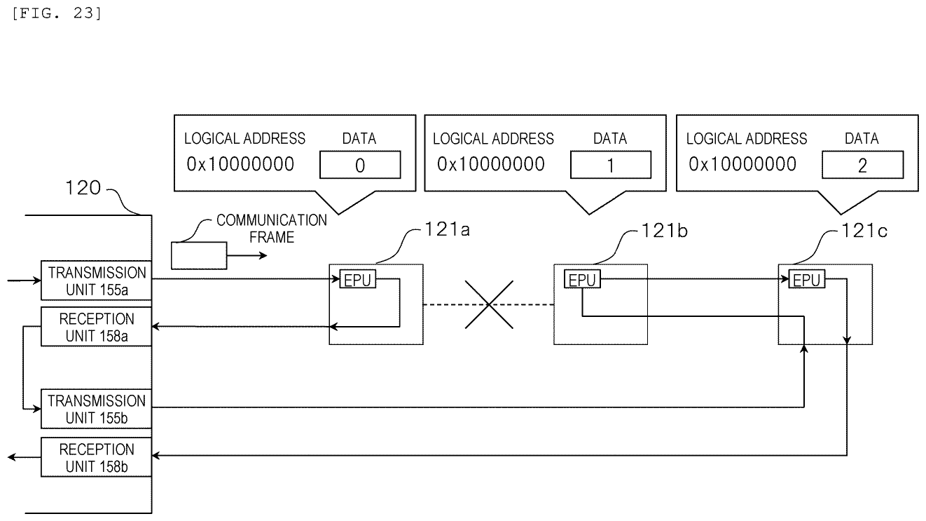

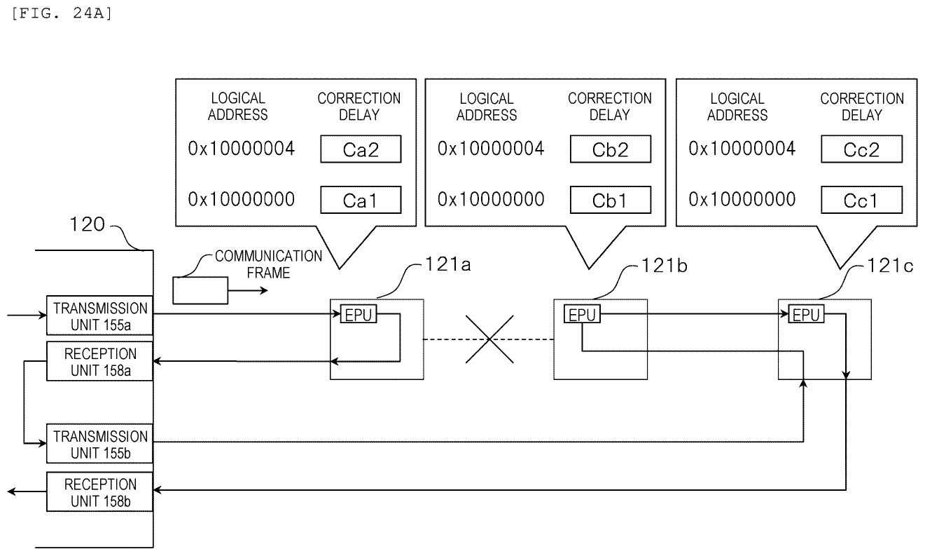

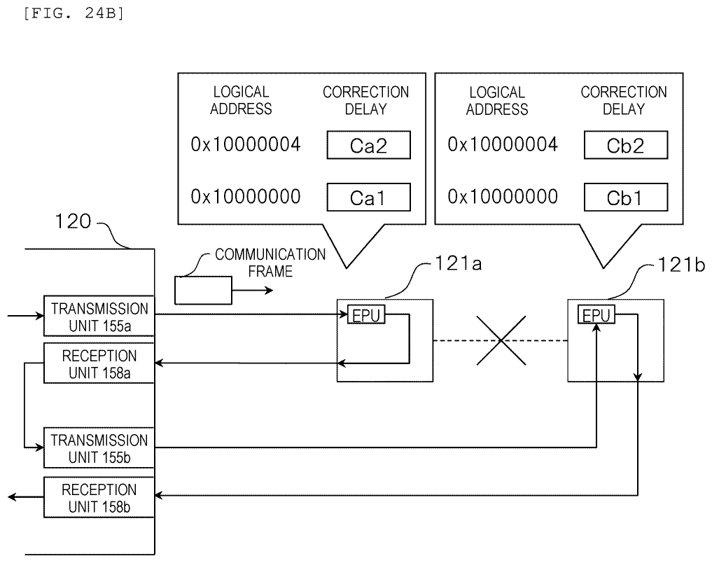

FIGS. 24A, 24B, and 24C are schematic diagrams showing an example of a method corresponding to a change in the system configuration using the mechanism of the logical address shown in FIG. 23. In the control system 123 shown in FIGS. 24A and 24B, unlike the case of FIG. 23, each control target device 121 stores correction delay information at the time of the path abnormality according to the system configuration at another logical address. Further, when the system configuration is changed, the control device 120 rapidly responds by changing the address 181 of the datagram generation information for acquiring the correction delay information.

The correction delay information stored by each control target device is a difference between a delay in the case in which the communication path with the adjacent control target device 121 is normal and a delay in the case in which the abnormality occurs in the communication path with the adjacent control target device 121. For example, as shown in FIG. 19A, the correction delay information stored by the control target device 121a is a difference between a communication delay when the communication frame propagates from the EPU of the control target device 121a to the EPU of the control target device 121b, and a communication delay when the communication frame propagates to the EPU of the control target device 121b via the reception unit 158a and the transmission unit 155b after the communication frame is returned by the EPU of the control target device 121a as shown in FIG. 24A. Such a correction delay information is also information that can be calculated in advance.

By storing the correction delay information in each control target device 121, the correction delay information is stored in the datagram of the LRD command received by the reception unit 158a at the time of the path abnormality. The redundant path control unit 200 uses the correction delay information to correct a reference time of the control target device 121, which serves as a time reference for time distribution datagrams in the DC protocol, thereby canceling an impact of increased delay due to a path abnormality on the control target device 121 subsequent to the path abnormality location. At this time, the control device 120 changes the logical address for storing the correction delay information of each control target device 121 according to the system configuration.

In FIG. 24A, the control system 123 includes the control target devices 121a, 121b, and 121c. In this case, the correction delay information is stored at the logical address 0x10000000. Ca1 is correction delay information stored by the control target device 121a, Cb1 is correction delay information stored by the control target device 121b, and Cc1 is correction delay information stored by the control target device 121a.

Here, FIG. 24B shows an example in which the system configuration is changed and the control target device 121c is removed. In FIG. 24B, the communication delay from the control target device 121a to the control target device 121b when an abnormality occurs in the communication path between the control target device 121a and the control target device 121b is shortened by the time passing through the control target device 121c as compared with FIG. 24A. That is, the correction delay information may vary depending on the system configuration, as shown in FIGS. 24A and 24B.

Therefore, in the configuration of FIG. 24B including the control target devices 121a and 121b, the control target devices 121a and 121b store the correction delay information at the logical address 0x10000004. Ca2 is a correction delay information stored by the control target device 121a, and Cb2 is a correction delay information stored by the control target device 121b. In the configuration shown in FIG. 24B, since the control target device 121c is removed, the control target device 121c does not store the correction delay information.

With this configuration, in step S064 shown in FIG. 13, when changing the datagram generation information according to the change in the system configuration, the datagram generation information change unit 161 may change the address 181 as shown in FIG. 24C. Specifically, the datagram generation information change unit 161 changes the logical address from 0x10000000 to 0x10000004. In this case, a storage destination logical address of the correction time information according to the system configuration is stored in advance as the datagram generation information as shown in FIG. 24C and the control system configuration information as shown in FIGS. 9B and 9D.

### Main Effects of Third Embodiment

By using the method according to the third embodiment, it is possible to obtain the effects same as those described in the first embodiment and the second embodiment. In addition, even when the system configuration is changed, the correction delay information can be changed immediately. When a single logical address is used as a comparison target, it is necessary to access a predetermined address of each control target device 121 to update the correction delay information. Therefore, it takes time to change the system configuration according to the number of control target devices 121 constituting the control system 123 and the time required to update the correction delay information of the control target devices 121.

On the other hand, the correction delay information according to the system configuration can be calculated in advance due to the features of the EtherCAT real-time network, and can be set in each control target device 121 during a setup stage of the control system 123. Therefore, when the system configuration is changed, the system configuration can be changed rapidly only by changing the access destination logical address as shown in FIG. 24C.

Although the invention made by the present inventor has been specifically described based on embodiments, the invention is not limited to the embodiments, and various modifications can be made without departing from the gist of the invention. For example, the above-described embodiments have been described in detail to facilitate understanding of the invention, and the invention is not necessarily limited to those including all the configurations described above. In addition, a part of a configuration according to a certain embodiment can be replaced with a configuration according to another embodiment, and a configuration according to another embodiment can be added to a configuration according to a certain embodiment. In addition, another configuration can be added to, deleted from, or replaced with a part of a configuration of each embodiment.

### REFERENCE SIGNS LIST

120: control device (control communication device)
121: control target device (device)
123: control system
153: datagram generation unit
159: Communication Unit
160: control target device selection unit
161: datagram generation information change unit
162: control system configuration information storage unit
163: abnormality determination unit
178: WKC

1. A control communication system comprising:
a control communication device including a communication unit configured to transmit a packet including control data; and
a plurality of devices communicably connected to a communication port formed in the communication unit and configured to operate according to the received packet, wherein
the packet includes a packet data area in which the control data is selected and arranged, and is transmitted from the communication unit to the device connected to the communication unit, and
the control communication device
generates the control data based on communication control information related to transmission and reception of the control data,
stores a correspondence relationship between the device and the control data, and
changes the communication control information related to the device based on the correspondence relationship when a state of the device is changed.

2. The control communication system according to claim 1, wherein
the control data includes an access content to a virtual area shared in the control communication system.

3. The control communication system according to claim 1, wherein
the communication control information includes an expected value when a verification parameter included in the control data is received by the communication unit of the control communication device, and
the verification parameter is determined based on the number of the devices that process the control data.

4. The control communication system according to claim 2, wherein
the communication control information includes an address of the virtual area.

5. The control communication system according to claim 1, wherein
the communication control information includes a size of the control data.

6. The control communication system according to claim 2, wherein
the correspondence relationship includes either or both of a correspondence between the device and the virtual area to which an address space of the device is assigned, or a correspondence between the control data and the virtual area accessed by the control data.

7. The control communication system according to claim 3, wherein
the control communication device retransmits a packet including the control data when the expected value and a value of the verification parameter at receiving the control data are not equal.

8. The control communication system according to claim 3, wherein
the control communication device includes a plurality of the communication units, and
when the control communication device receives the packet, the control communication device executes, based on the expected value set for the communication unit that receives the packet and a value of the verification parameter of the control data included in the packet, at least one of determining whether there is an abnormality in a communication path to the device, identifying the device adjacent to the communication path, and retransmitting the packet including the control data from any one of the plurality of communication units.

9. The control communication system according to claim 8, wherein
the communication control information includes the total number of the devices, and
when the control communication device receives the packet, when a value of the verification parameter of the control data included in the packet is equal to the total number, the control communication device does not retransmit the packet including the control data.

10. The control communication system according to claim 4, wherein
communication delay correction information when an abnormality occurs in a communication path between a first device and an adjacent second device is determined based on a configuration of the control communication system,
the communication delay correction information corresponding to a different configuration of the control communication system is stored in different virtual areas,
the correspondence relationship includes a correspondence between the device and an address of the virtual area in which the communication delay correction information according to the configuration of the control communication system is stored,
the communication control information includes an address of the virtual area in which the communication delay correction information is stored, and
when the configuration of the control communication system is changed, the control communication device changes an address to be included in the control data to an address of the virtual area storing the communication delay correction information corresponding to the configuration of the control communication system, based on the correspondence relationship.

11. The control communication system according to claim 4, wherein
an address space of the device to be changed in the control communication system is assigned by being aggregated on the virtual area.

12. The control communication system according to claim 7, wherein
the control communication device sets a period for invalidating processing based on the verification parameter when the packet is received while the state of the device is changed.

13. The control communication system according to claim 1, wherein
the correspondence relationship includes a correspondence relationship between the device in a possible maximum configuration where the control communication system is in operation and the control data.

14. The control communication system according to claim 1, wherein
the correspondence relationship includes a connection order of the devices, and
the control communication device verifies the connection order of the devices based on the correspondence relationship when the state of the device is changed.

15. The control communication system according to claim 1, wherein
the control communication device includes a plurality of the communication units, and
the communication control information is defined for each of the communication units.

16. The control communication system according to claim 1, wherein
a change factor of a system configuration in the control communication system is associated with the device that is to be subject to a state change.

17. The control communication system according to claim 16, wherein
the control communication device periodically transmits the control data for detecting a change in the system configuration in the control communication system, and automatically detects the change of the system configuration in the control communication system.

18. The control communication system according to claim 1, wherein
the correspondence relationship associates a group of the plurality of devices with the control data.

19. The control communication system according to claim 8, wherein
the control communication device sets a period for invalidating processing based on the verification parameter when the packet is received while the state of the device is changed.
